(19) United States
(12) Patent Application Publication
(10) Pub. No.: US 2024/0307992 A1
(43) Pub. Date: Sep. 19, 2024

(54) SPOT WELDED JOINT AND METHOD OF MANUFACTURING SPOT WELDED JOINT

(71) Applicant: NIPPON STEEL CORPORATION, Tokyo (JP)

(72) Inventors: Chisato YOSHINAGA, Chiyoda-ku, Tokyo (JP); Masanori YASUYAMA, Chiyoda-ku, Tokyo (JP); Aoshi KAWAI, Chiyoda-ku, Tokyo (JP); Matsuo KAYANO, Chiyoda-ku, Tokyo (JP)

(21) Appl. No.: 18/264,933

(22) PCT Filed: Mar. 29, 2022
(86) PCT No.: PCT/JP2022/015612

§ 371 Date: Aug. 10, 2023

(30) Foreign Application Priority Data
Mar. 30, 2021 (JP) 2021-058351
Mar. 30, 2021 (JP) 2021-058352

(51) Int. Cl. B23K 11/16; B23K 11/11; C22C 38/00; C22C 38/02; C22C 38/04; C22C 38/06; C22C 38/42; C22C 38/44; C22C 38/46; C22C 38/48; C22C 38/50; C22C 38/54

(52) U.S. Cl. CPC B23K 11/16; B23K 11/11; C22C 38/001; C22C 38/002; C22C 38/005; C22C 38/02; C22C 38/04; C22C 38/06; C22C 38/42; C22C 38/44; C22C 38/46; C22C 38/48; C22C 38/50; C22C 38/54

(57) ABSTRACT

A spot welded joint is provided in which, in a cross section in a sheet thickness direction of a sheet set in which two or more steel sheets including at least one steel sheet having a C content of 0.280% by mass or more and 0.700% by mass or less overlap, an average of ratios of major axes to minor axes (major axes/minor axes) of prior austenite grains in a melting boundary region, which is up to 1 mm inside a melting boundary of a nugget end portion, is in a range of 1.0 to 1.5, and the number density of iron-based carbides having an equivalent circle diameter of 30 nm or more in the melting boundary region is 3.0×10⁶×C content (mass %) or more per 1 mm². The sheet set, in which the C content of at least one steel sheet is 0.280% by mass or more and 0.700% by mass or less, is spot welded under a specific condition, and then tempered under a specific condition.

### TECHNICAL FIELD

The present disclosure relates to a spot welded joint and a method of manufacturing a spot welded joint.

### BACKGROUND ART

Spot welding is mainly used in processes such as assembly of vehicle bodies and attachment of components.

In recent years, in the automotive fields, weight reduction of a vehicle body for achieving low fuel consumption and reduction of CO₂ emission, and high rigidity of the vehicle body for improving collision safety are further required, and the need to use high-strength steel sheets for vehicle bodies and components and the like in order to satisfy the requirements increases.

Meanwhile, the high-strength steel sheet has a large carbon equivalent (Ceq) of a base material in order to achieve its strength, and in spot welding, a welded portion is rapidly cooled after being heated, so that the welded portion has a martensitic structure, and the welded portion and a heat-affected zone have increased hardness and decreased toughness.

As a method of improving the toughness of a spot welded portion to secure joint strength, a method of further performing post-heating energization after main energization has been proposed.

For example, Patent Document 1 discloses, as a spot welding method by three-stage energization, a resistance spot welding method in which a sheet set in which two or more steel sheets are overlapped is clamped between a pair of electrodes, and energized to be joined while being pressurized. In the resistance spot welding method, a main energization step of energizing at a current value I_{w} (kA) is performed. Then, as a post-tempering heat treatment step, after cooling for a cooling time t_{ct} (ms) represented by the formula (1), energization is performed for an energization time tₜ (ms) represented by the formula (3) at a current value Iₜ (kA) represented by the formula (2),

$$800 \leq {t}_{ct} \qquad formula ( 1 )$$

$$0.5 \times {I}_{w} \leq {I}_{t} \leq {I}_{w} \qquad formula ( 2 )$$

$$500 \leq {t}_{t} . \qquad formula ( 3 )$$

At least one steel sheet of the sheet set includes

0.08≤C≤0.3 (% by mass),

0.1≤Si≤0.8 (% by mass),

2.5≤Mn≤10.0 (% by mass),

P≤0.1 (% by mass), and

the balance being Fe and unavoidable impurities.

Patent Document 2 discloses a method of overlapping and spot welding high-strength steel sheets containing 0.15% by mass or more of carbon and having tensile strength of 980 MPa or more. In the method, a spot welding step is divided into three steps of a first energization step of forming a nugget, a cooling step of non-energizing the nugget following the first energization step, and a second energization step of softening the nugget following the cooling step. At that time, when a current in the first energization step is I₁ and a current in the second energization step is I₂, I₂/I₁ is set to 0.5 to 0.8. A time tc (sec) in the cooling step is set to a range of 0.8×t min or more and 2.5×t min or less calculated according to the following formula (1) according to a steel sheet thickness H (mm), and an energization time t2 (sec) in the second energization step is set to a range of 0.7×t min or more and 2.5×t min or less. A pressurizing force of an electrode after the cooling step is more than a pressurizing force of an electrode until the first energization step to obtain a spot welded joint.

$$t min = 0.2 \times {H}^{2} \qquad ( 1 )$$

Patent Document 3 discloses a high-strength steel sheet spot welded joint including:

two or more thin steel sheets spot welded to each other; and

a nugget formed at a joint surface of the thin steel sheets, wherein

at least one of the two or more thin steel sheets is a high-strength steel sheet having tensile strength of 750 MPa to 1850 MPa, and a carbon equivalent Ceq of 0.22% by mass to 0.55% by mass represented by the following formula (1),

in a nugget outer layer region excluding a 90% homomorphic region of the outer shape of the nugget in the nugget,

a microstructure has dendrite structure in which an average value of arm intervals is 12 μm or less, and a carbide contained in the microstructure has an average grain diameter of 5 nm to 100 nm and a number density of 2×10⁶/mm² or more.

$$Ceq = [ C ] + [ Si ] / 30 + [ Mn ] / 20 + 2 [ P ] + 4 [ S ] \qquad ( 1 )$$

([C], [Si], [Mn], [P] and [S] represent the contents (% by mass) of C, Si, Mn, P and S, respectively)
Patent Document 1: International Publication WO2019/156073
Patent Document 2: International Publication WO2014/171495
Patent Document 3: International Publication WO2011/025015

### SUMMARY OF INVENTION

### Technical Problem

The strength of the joint base material (steel sheet) can be increased by increasing the carbon amount in the steel sheet used for spot welding. However, in the high Ceq material, the strength of the spot welded joint decreases.

For example, Patent Document 1 describes that a steel sheet having a C content of 0.08 to 0.3% is essentially used, and as Comparative Example, joint strength decreases when three-stage energization is performed using a steel sheet having a C content exceeding 0.3%. However, in Example of Patent Document 1, a steel sheet having a C content of 0.2% or less is used, and a steel sheet having a C content of 0.28% is used as Comparative Example.

In order to improve the collision performance of spot welded members, a welded joint having high joint strength is desirably manufactured.

An object of the present disclosure is to provide a spot welded joint having joint strength greatly improved as compared with a case where a sheet set including a steel sheet having a relatively high carbon amount is subjected to resistance spot welding by single energization.

An object of the present disclosure is to provide a method of manufacturing a spot welded joint capable of greatly improving joint strength as compared with a case of performing resistance spot welding by single energization even in a case of using a sheet set including a steel sheet having a relatively high carbon amount.

### Solution to Problem

The gists of the present disclosure for achieving the above objects are as follows.
<1> A spot welded joint of a sheet set in which two or more steel sheets, including at least one steel sheet having a C content of 0.280% by mass or more and 0.700% by mass or less, overlap, wherein:
   in a cross section of the sheet set in a sheet thickness direction passing through a central portion of a nugget, an average of ratios of major axes to minor axes (major axes/minor axes) of prior austenite grains in a melting boundary region, which is up to 1 mm inside a melting boundary of a nugget end portion corresponding to a portion that had been a sheet interface, is in a range of 1.0 to 1.5, and a number density of iron-based carbides having an equivalent circle diameter of 30 nm or more in the melting boundary region is 3.0×10⁶×C or more per 1 mm² in a case in which the C content (% by mass) in the steel sheet constituting the sheet set is regarded as C, in which, in a case in which C contents of all the steel sheets constituting the sheet set are not the same, the C for calculating a lower limit value of the number density of the iron-based carbides is a weighted average of values obtained by multiplying the C content in each of the steel sheets constituting the sheet set by a sheet thickness ratio of each of the steel sheets with respect to a total thickness of the sheet set.
<2> The spot welded joint according to <1>, wherein the C contents of all the steel sheets constituting the sheet set are more than 0.300% by mass.
<3> The spot welded joint according to <1> or <2>, wherein, in a case in which a C content (% by mass) in a steel sheet having a highest C content in the sheet set is regarded as [C], a tensile strength (MPa) of the steel sheet having the highest C content is 1800×[C]+250 or more.
<4> The spot welded joint according to any one of <1> to <3>, wherein the number density of the iron-based carbides having the equivalent circle diameter of 30 nm or more in a region within 500 μm from the nugget end portion of a heat-affected zone present around the nugget end portion is 1.0×10⁶×C or more per 1 mm².
<5> The spot welded joint according to any one of <1> to <4>, wherein a residual stress in the central portion of the nugget is less than 90 MPa.
<6> A method of manufacturing a spot welded joint, the method including:
   a first energization step of energizing a sheet set in which two or more steel sheets, including at least one steel sheet having a C content of 0.280% by mass or more and 0.700% by mass or less, overlap at a current value I₁ (kA) while clamping the sheet set in a sheet thickness direction between a pair of electrodes and pressurizing the sheet set;
   a first non-energization step of non-energizing the sheet set for a time t_{c1} of 20 ms or more and 200 ms or less after the first energization step;
   a second energization step of energizing the sheet set at a current value I₂ (kA) satisfying the following formula (1) for a time t₂ (ms) satisfying the following formula (2), after the first non-energization step:

$$0.6 \leq {I}_{2} / {I}_{1} \leq 1.1 \qquad ( 1 )$$

$$50 \leq {t}_{2} \leq 1000 ; \qquad ( 2 )$$

and
a tempering step of performing tempering under a condition that a tempering temperature is 350° C. or higher and a tempering parameter H calculated according to the following formula (A) is 8000 or more and 18000 or less at the energized position after the elapse of a time t_{c2} (ms) satisfying the following formula (3), after the second energization step:

$${t}_{c 2} > 3.5 \times {10}^{- 3} \times {Ms}^{2} - 3.3 \times Ms + 1100 \qquad ( 3 )$$

$$H = T \times ( log {t}_{HT} + ( 17.7 - 5.8 \times [ C ] ) ) \qquad ( A )$$

wherein:
Ms in the formula (3) means an Ms point calculated by substituting % by mass of each element contained in the steel sheet constituting the sheet set into an element symbol in the following formula (4), in which, in a case in which all the steel sheets constituting the sheet set do not have the same composition, an Ms point of a weighted average of values obtained by multiplying the Ms point calculated for each steel sheet according to the formula (4) for all the steel sheets constituting the sheet set by a sheet thickness ratio of each steel sheet with respect to a total thickness of the sheet set is substituted into the formula (3):

$$Ms ( ° C . ) = 561 - 474 \times C - 33 \times Mn - 17 \times Ni - 17 \times Cr - 21 \times Mo , \qquad ( 4 )$$

in the formula (A), T means a tempering temperature (K) in a vicinity of a nugget end portion formed by the energization; t_{HT} means a tempering time (s); and [C] means a C content (% by mass) in a steel sheet having a highest C content in the sheet set.
<7> The method of manufacturing a spot welded joint according to <6>, wherein, in the tempering step, the tempering is performed using a heating means selected from the group consisting of a furnace, a laser, a burning iron, a hot plate, and high-frequency induction heating.
<8> The method of manufacturing a spot welded joint according to <6> or <7>, wherein: the tempering is performed so that the tempering temperature T is (A_{c1}-30° C.) or lower in the tempering step in a case in which a value calculated according to the following formula (B) is regarded as A_{c1} (° C.):

$${A}_{c 1} ( ° C . ) = 750.8 - 26.6 C + 17.6 Si - 11.6 Mn - 22.9 Cu - 23 Ni + 24.1 Cr + 22.5 Mo - 39.7 V - 5.7 Ti + 232.4 Nb - 169.4 Al - 894.7 B , \qquad ( B )$$

and
   % by mass of each element contained in the steel sheet constituting the sheet set is substituted into an element symbol in the formula (B), in which, in a case in which all the steel sheets constituting the sheet set do not have the same composition, the (A_{c1}-30) is determined based on A_{c1} of a weighted average of values obtained by multiplying A_{c1} calculated according to the formula (B) for each steel sheet for all the steel sheets constituting the sheet set by the sheet thickness ratio of each steel sheet with respect to the total thickness of the sheet set.
<9> The method of manufacturing a spot welded joint according to any one of <6> to <8>, wherein the C contents of all the steel sheets constituting the sheet set are more than 0.300% by mass.
<10> The method of manufacturing a spot welded joint according to any one of <6> to <9>, wherein, in a case in which a C content (% by mass) in a steel sheet having a highest C content in the sheet set is regarded as [C], the spot welded joint is manufactured in which a tensile strength (MPa) of the steel sheet having the highest C content is 1800×[C]+250 or more.
<11> The method of manufacturing a spot welded joint according to any one of <6> to <10>, wherein the t_{c2} is 9000 msec or less.
<12> The method of manufacturing a spot welded joint according to any one of <6> to <11>, wherein, in the first energization step, the first non-energization step, and the second energization step, a pressuring force applied to the sheet set by the pair of electrodes is constant.

### Advantageous Effects of Invention

The present disclosure provides a spot welded joint having joint strength greatly improved as compared with a case where a sheet set including a steel sheet having a relatively high carbon amount is subjected to resistance spot welding by single energization.

The present disclosure provides a method of manufacturing a spot welded joint capable of greatly improving joint strength as compared with a case of performing resistance spot welding by single energization even in a case of using a sheet set including a steel sheet having a relatively high carbon amount.

### BRIEF DESCRIPTION OF DRAWINGS

FIG. 1 is a view illustrating a relationship between spot welding to which overlapped steel sheets are subjected and CTS (cross tensile strength) of a joint.

FIGS. 2(A) and 2(B) are SEM-EBSD analysis images near a nugget after spot welding, in which FIG. 2(A) illustrates a case where only single energization is performed, and FIG. 2(B) illustrates a case where second energization is performed after single energization.

FIG. 3 is a view illustrating a cross section in a sheet thickness direction around the nugget.

FIGS. 4(A) and 4(B) are views illustrating an SEM-EBSD analysis image and a prior austenite grain boundary, which are examples of the structure of a nugget end portion when a spot welded joint is manufactured by single energization.

FIGS. 5(A) and 5(B) are views illustrating an SEM-EBSD analysis image and a prior austenite grain boundary, which are examples of the structure of a nugget end portion of a spot welded joint according to the present disclosure.

FIG. 6 is a view illustrating an example of the structure of a nugget end portion of a spot welded joint, and illustrating an iron-based carbide (white portion).

FIG. 7 is a view schematically illustrating a combination of spot welding and tempering in a method of manufacturing a spot welded joint according to the present disclosure.

FIG. 8 is a view schematically illustrating an example of a nugget and a heat-affected zone (HAZ) formed when a sheet set in which two steel sheets are overlapped is subjected to resistance spot welding.

FIG. 9 is a view illustrating a relationship between an Ms point and a time required for cooling to the Ms point after segregation is relaxed.

FIG. 10 is a view illustrating an example of a temperature history of thermal conduction analysis of the vicinity of the nugget end portion when tempering is performed using a spot welding machine.

FIG. 11 is a view illustrating an average temperature change when the temperature history illustrated in FIG. 10 is divided into ranges not exceeding 50° C.

### DESCRIPTION OF EMBODIMENTS

Hereinafter, an exemplary embodiment of the present disclosure will be described.

In the present disclosure, the description “%” used to describe the content of each element means the content thereof in “% by mass”. In the present disclosure, any numerical range described using the expression “from * to” refers to a range in which numerical values described before and after the “to” are included as a lower limit value and an upper limit value of the range, unless otherwise defined. Any numerical range in which the expression “more than” or “less than” is attached to the numerical value(s) described before or after the “to” refers to a range which does not include the numerical value(s) as the lower limit value or the upper limit value.

In a numerical range described in stages, in the present disclosure, the upper limit value of a certain numerical range described in stages may be replaced with the upper limit value in another numerical value described in stages, or a value shown in Examples. In a numerical range described in stages, in the present disclosure, the lower limit value of a certain numerical range described in stages may be replaced with the lower limit value in another numerical value described in stages, or a value shown in Examples.

The definition of the term “step” includes not only an independent step, but also a step which is not clearly distinguishable from another step, as long as the intended purpose of the step is achieved.

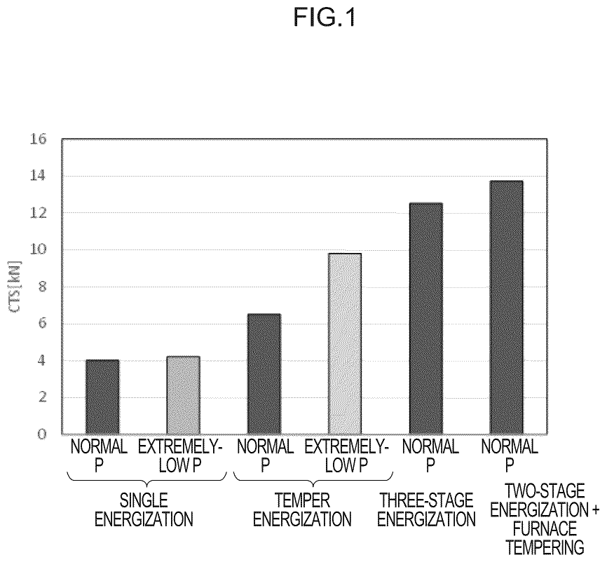

The present inventors have intensively studied a method capable of improving joint strength (cross tensile strength: CTS) when resistance spot welding is performed even when the amount of C in the steel sheet is more than 0.150% by mass, particularly 0.280% or more. FIG. 1 illustrates a relationship with the CTS of a joint obtained by superimposing two steel sheets of the same type, the two types of steel sheets being a normal P material having an amount of P of 0.015% and an extremely-low P material having an amount of P of 0.0007%, the amount of C in the two types of steel sheets being 0.34%, and subjecting the steel sheets to resistance spot welding. Note that components other than C and P are common in having S: 0.0008%, Si: 0.25%, and Mn: 1.25%. “Single energization” means that a sheet set is subjected to resistance spot welding by one energization for forming a nugget, and “temper energization” means that a sheet set is subjected to single energization for forming a nugget, and then subjected to post-energization (temper energization) corresponding to an annealing treatment for softening the nugget. “Three-stage energization” means that after single energization for forming a nugget, energization is performed at a current value larger than that of temper energization, and then temper energization is performed. “Two-stage energization+furnace tempering” means that after single energization for forming a nugget, energization is performed at a current value larger than that of temper energization, and tempering is then performed using a tempering furnace.

When joint strengths are examined using steel sheets in which components are changed, it is found that joint strength achieved in an extremely-low P amount when the temper energization is performed is higher than that in a normal P amount. Therefore, it is found that, if energization for the purpose of alleviating segregation is added when a joint of normal P is subjected to temper energization or tempering in a furnace, higher strength can be obtained, but the joint strength is increased to such an extent that it cannot be explained only by the effect of alleviating segregation.

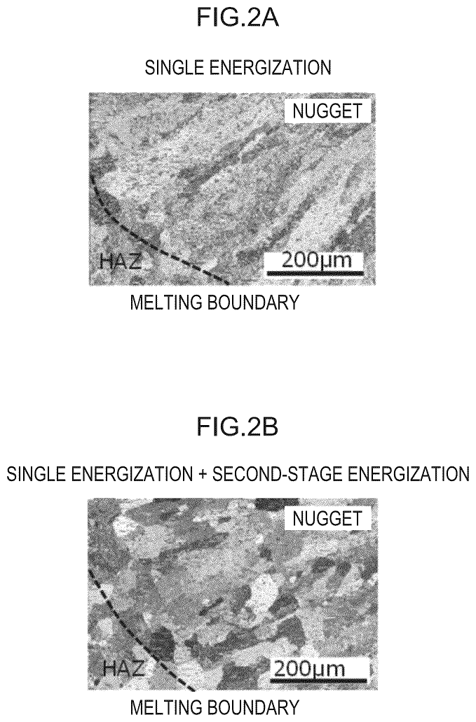

As a cause of this, it is considered that the energization performed again after the nugget is formed has not only an effect of alleviating segregation but also an effect of changing the shape of prior austenite grains. FIG. 2 is an image obtained by performing SEM-EBSD analysis on the nugget and the vicinity thereof in the case of spot welding. FIG. 2(A) illustrates a case where only single energization is performed, and FIG. 2(B) illustrates a case where second-stage energization is performed for 0.1 seconds after the single energization (no temper energization). When a large angle grain boundary of 15 degrees or more is observed, regulated grains that are not often seen in FIG. 2(A) are observed in the vicinity of a nugget end portion (in the vicinity of a melting boundary) in the nugget in FIG. 2(B). A particle diameter and a shape are considered to be changed by solidification once followed by reheating to cause 8 transformation and recooling to cause γ transformation, and toughness is considered to be improved by the grain size regulation. In a high C material in which C is more than 0.150%, and particularly 0.280% or more, the grain size regulation is considered to be more important than segregation alleviation.

After such two energizations, a weld portion is tempered using various heat sources, and as a result of examination, when T: tempering temperature (K), t_{HT}: tempering time (s), and [C]: C content (% by mass) in the steel sheet are defined, tempering is performed so that an tempering parameter H that can be calculated from the temperature history of the nugget end portion is within a specific range, whereby the CTS is remarkably improved as compared with the joint by single energization.

In general, the tensile strength of the steel sheet increases as the C content increases, but the toughness of the welded portion decreases and the joint strength decreases. However, the present inventors have considered that in a steel sheet having a C content of 0.280% or more, not only segregation alleviation but also grain size regulation is important. The present inventors have found that if spot welding combining an energization step of forming a nugget under a specific condition with a grain size regulation energization step is performed even in a sheet set including a steel sheet having a C content of 0.280% or more and 0.700% or less, and tempering is performed so that a value of an tempering parameter H falls within a specific range after the elapse of a specific time, the toughness of a portion (near a nugget boundary in the nugget) to which a stress in a peeling direction is most applied in a CTS test can be improved, and the joint strength can be significantly improved.

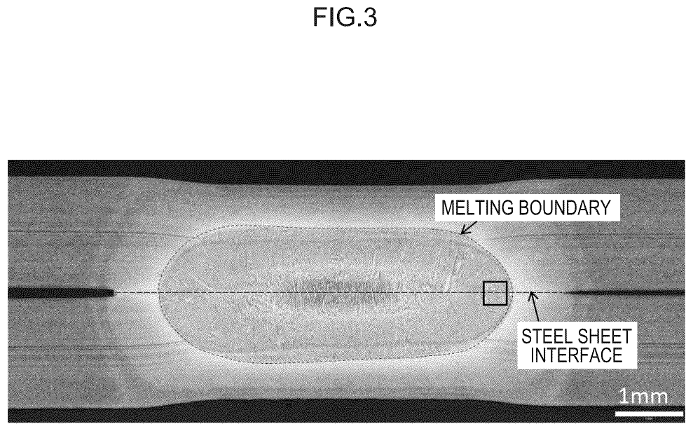

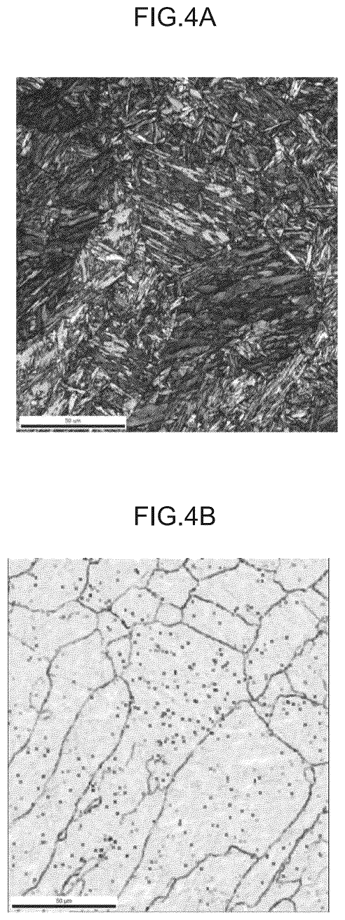

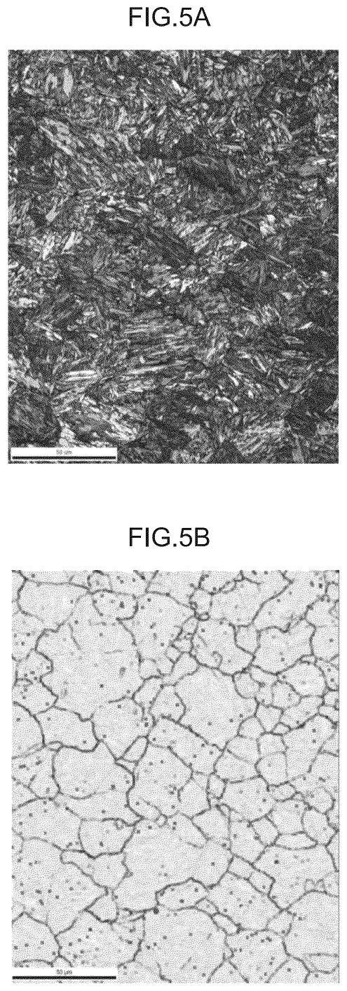

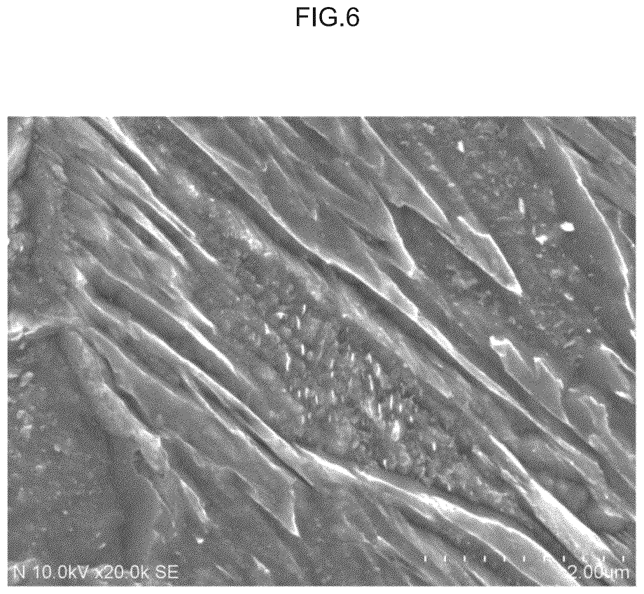

Furthermore, a spot welded joint using a steel sheet having a relatively high carbon amount was investigated by observing the cross section of a nugget as illustrated in FIG. 3 and subjecting the spot welded joint to a CTS test and the like. FIG. 4 illustrates the structure of the nugget end portion when the spot welded joint was manufactured by single energization, and FIG. 5 illustrates the structure of the nugget end portion of the spot welded joint subjected to three-stage energization under a specific condition. FIGS. 4(A) and 5(A) illustrate images obtained by SEM-EBSD analysis, and FIGS. 4(B) and 5(B) illustrate grain boundaries of prior austenite grains. Compared with the prior austenite grains illustrated in FIG. 4(B), the prior austenite grains illustrated in FIG. 5(B) are regulated grains having a small aspect ratio. FIG. 6 illustrates an iron-based carbide (white portion) at the nugget end portion.

From such analysis results, the present inventors have found that when the following (I) and (II) are satisfied in a melting boundary region up to 1 mm inside a melting boundary of a nugget end portion corresponding to a portion that had been a sheet interface in a spot welded joint using a steel sheet having a C content of 0.280% by mass or more and 0.700% by mass or less, CTS is remarkably improved as compared with a welded joint in which spot welding is performed by single energization.
(I) The average of ratios of the major axes to the minor axes (major axes/minor axes) of the prior austenite grains is 1.0 to 1.5.
(II) The number density of an iron-based carbide having an equivalent circle diameter of 30 nm or more when the C content (% by mass) in the steel sheet is C is 3.0×10⁶×C or more per 1 mm².

### [Spot Welded Joint]

Hereinafter, a spot welded joint according to the present disclosure will be described in detail. In the present disclosure, the “spot welded joint” may be referred to as a “welded joint” or simply a “joint”.

The “nugget end portion corresponding to the portion that had been the sheet interface” may be referred to as the “nugget end portion”.

The “region up to 1 mm inside a melting boundary” may be referred to as the “melting boundary region”.

“The average of ratios of the major axes to the minor axes (major axes/minor axes) of the prior austenite grains” may be referred to as “the average aspect ratio of the prior austenite grains”.

“The iron-based carbide having an equivalent circle diameter of 30 nm or more” may be referred to as “the coarse iron-based carbide”.

For example, “in the cross section of the sheet set in the sheet thickness direction, the average of ratios of the major axes to the minor axes (major axes/minor axes) of the prior austenite grains in the melting boundary region up to 1 mm inside a melting boundary of a nugget end portion corresponding to a portion that had been a sheet interface” may be referred to as “the average aspect ratio of the prior austenite grains in the nugget end portion”, and “in the cross section of the sheet set in the sheet thickness direction, the number density of the iron-based carbides having an equivalent circle diameter of 30 nm or more in the melting boundary region up to 1 mm inside a melting boundary of a nugget end portion corresponding to a portion that had been a sheet interface” may be referred to as “the number density of the coarse iron-based carbides in the nugget end portion”.

### (Average Aspect Ratio of Prior Austenite Grains in Nugget End Portion)

In the welded joint according to the present disclosure, the average aspect ratio of the prior austenite grains in the nugget end portion is in the range of 1.0 to 1.5. When the conditions of the method of manufacturing a spot welded joint according to the present disclosure to be described later are not satisfied, austenite grains extending in a solidification direction tend to be formed.

The spot welded joint is weak with respect to a force in a direction of peeling the overlapped sheets, and the joint strength deteriorates. Therefore, the average aspect ratio of the prior austenite grains in the nugget end portion is set to 1.0 to 1.5, preferably 1.3 or less, and more preferably 1.2 or less.

In the present disclosure, the average aspect ratio of the prior austenite grains in the nugget end portion is specified as follows.

For example, in an image illustrating a prior austenite grain boundary as illustrated in FIGS. 4(B) and 5(B), the shape of each prior austenite grain is elliptically approximated by a least squares method. In the elliptical approximation method, the major axis and the area of each austenite grain are used to calculate the minor axis of the ellipse having the major axis. In this elliptical shape, the aspect ratio of the prior austenite grain is calculated by dividing the dimension of the major axis by the dimension of the minor axis.

Specifically, the nugget is cut in the sheet thickness direction so as to pass through the center portion of the nugget, and the aspect ratio of the prior austenite grain boundary is measured in an observation area of 0.25 mm² at an observation magnification of 50 times by SEM-EBSD for the melting boundary region of the nugget end portion in the cross section. Measurement is performed in the melting boundary region of the nugget end portion, and the average value thereof is an average aspect ratio. The number of the prior austenite grains in the melting boundary region of the nugget end portion for calculating the average aspect ratio is 15 or more. The aspect ratio of the prior austenite grain boundary may be measured in the melting boundary region of one end portion of the nugget, but if the prior austenite grain size is large and 15 or more grains cannot be measured, the total observation area is set to 0.25 mm² or more by measuring in both end portions of the nugget, and the shape of the prior austenite grains included therein is used. At this time, even if the sizes of the grains included therein are out of the range of 0.25 mm², the grains are used for the calculation.

In the case of a joint portion in which three or more steel sheets are overlapped and spot welded, the measurement is performed in the nugget end portion of the interface of the steel sheet having the highest carbon amount, and in the case in which steel sheets are present above and below the steel sheet, the measurement is performed in the nugget end portion of the interface of the steel sheet having a higher carbon amount above and below the steel sheet.

### (Number Density of Iron-Based Carbide in Nugget End Portion)

In the welded joint according to the present disclosure, the number density of the iron-based carbides (coarse iron-based carbides) having an equivalent circle diameter of 30 nm or more in the nugget end portion is 3.0×10⁶×C or more per 1 mm². When the number density of the coarse iron-based carbides in the nugget end portion is 3.0×10⁶×C/mm² or more, sufficient tempering proceeds, and high joint strength can be obtained. The number density of the coarse iron-based carbides in the nugget end portion is preferably 3.3×10⁶×C/mm² or more, and more preferably 4.0×10⁶×C/mm² or more.

Meanwhile, when the number density of the coarse iron-based carbides in the nugget end portion is too large, the toughness may be reduced, and thus the number density is preferably 5.0×10⁸×C/mm² or less, and more preferably 3.0×10⁸×C/mm² or less.

Note that C substitutes the C content (% by mass) in the steel sheet constituting the sheet set, but when the C contents in the steel sheets constituting the sheet set are different, a weighted average of values obtained by multiplying the C content in each of the steel sheets constituting the sheet set by the sheet thickness ratio of each of the steel sheets with respect to the total thickness of the sheet set is substituted.

In the present disclosure, the number density of the coarse iron-based carbides in the nugget end portion is specified as follows.

In the cross section cut in the sheet thickness direction so as to pass through the center portion of the nugget, the melting boundary region including the corresponding position of the nugget end portion is mirror-polished, and then etched with nital. Thereafter, SEM observation (magnification: 20,000 times) is performed, and the composition of a precipitate, which is considered to be an iron-based carbide, is specified by energy dispersive X-ray spectrometry (EDS). The iron-based carbide referred to herein is mainly cementite (Fe₃C) which is a compound of iron and carbon, and &-based carbide (Fe₂₋₃C) and the like. In addition to these iron-based carbides, a compound in which an Fe atom in cementite is substituted with Mn or Cr or the like, or an alloy carbide (M₂₃C₆, M₆C, and MC and the like, wherein M represents Fe and other metal elements) may be contained. Among these iron-based carbides, the number density of those having an equivalent circle diameter of more than 30 nm may be measured, as a field of view, in 50 μm square or more of the nugget end portion where the aspect ratio of the prior austenite grain boundary is measured.

### (Steel Sheet)

In the welded joint and the method of manufacturing the welded joint according to the present disclosure, at least one of the steel sheets constituting the sheet set may have a C content of 0.280% by mass or more and 0.700% by mass or less. The number of the steel sheets constituting the sheet set is not particularly limited as long as it is two or more, and may be selected according to the application of the welded joint to be manufactured. Hereinafter, the steel sheets in the welded joint and the method of manufacturing the welded joint according to the present disclosure will be described.

### C: 0.280% or More and 0.700% or Less

C is an element that enhances the hardenability of steel to contribute to the improvement of the strength of the steel. When only steel sheets having a C content of less than 0.280% are spot welded in a state where the steel sheets are overlapped, the joint strength can be secured without applying the welded joint according to the present disclosure. Therefore, in the welded joint according to the present disclosure, the C content of at least one steel sheet is set to 0.280% or more. Preferably, the C content of all the steel sheets constituting the welded joint according to the present disclosure is 0.280% or more, more preferably more than 0.300%, still more preferably 0.310% or more, yet still more preferably 0.330% or more, and further preferably 0.350% or more.

However, if the C content is more than 0.700%, the toughness is too low, and even when the welded joint according to the present disclosure is applied, only low CTS can be obtained, so that the C content is set to 0.700% or less. The C content is preferably 0.550% or less, and more preferably 0.480% or less.

The balance other than C may be Fe and impurities, or may contain an optional component instead of a part of Fe. The impurities are exemplified by a component contained in a raw material such as ore or scrap, or a component mixed in a manufacturing process, and refer to a component that is not intentionally contained in a steel sheet. Hereinafter, preferred contents of components other than C and Fe will be described. The components described below are impurities or optional components, and the lower limit value thereof may be 0%, or more than 0%.

### P: 0.010% or Less

P is an impurity and is an element that causes embrittlement. When the P content is more than 0.010%, it is difficult to obtain joint strength, and thus the upper limit of the P content is preferably set to 0.010%. The P content is more preferably 0.009% or less.

The P content is preferably lower, but the lower the P content is, the higher the dephosphorization cost is. According to the welded joint according to the present disclosure, as illustrated in FIG. 1, even when a steel sheet having a normal P content is used, CTS can be improved to be equal to or greater than that in a case where temper energization is performed after a nugget is formed by energization using a steel sheet having an extremely low P content. Therefore, it is not necessary to greatly reduce the P content in the steel sheet, and the lower limit value of the P content may be 0.0005%.

### S: 0.050% or Less

Like P, S is an impurity and is an element that causes embrittlement. S is an element that forms coarse MnS in steel, lowers the workability of the steel, and also lowers joint strength. When the S content is more than 0.050%, it is difficult to obtain required joint strength, and the workability of the steel is deteriorated, so that it is desirable to set the S content to 0.050% or less.

The S content is preferably smaller, but from the same viewpoint as that of P, the lower limit value of the S content in the steel sheet may be 0.0003%.

Si: More than 0.10%

Si is an element that increases the strength of steel by solid solution strengthening and structure strengthening. When the Si content is 0.10% or less, joint strength is reduced, and thus the lower limit of the Si content is preferably more than 0.10%. The Si content is more preferably more than 0.80%.

Meanwhile, when the Si content is too high, the workability is deteriorated and the joint strength is also reduced, whereby the upper limit of the Si content may be set to 3.5% or 3.0%.

### Mn: 15.00% or Less

Mn is an element that increases the strength of steel. When the Mn content is more than 15.00%, the workability is deteriorated and the joint strength is also reduced, whereby the upper limit of the Mn content is preferably set to 15.00%. In order to secure the strength and workability of the steel sheet and the joint strength in a well-balanced manner, the Mn content is more preferably 0.5 to 7.5%. The Mn content is more preferably 1.0 to 3.5%.

### Al: 3.00% or Less

Al is an element having a deoxidizing action, and is an element that stabilizes ferrite and suppresses the precipitation of cementite. Al is contained for deoxidation, and control of a steel structure, but Al is easily oxidized. When the Al content is more than 3.00%, the number of inclusions increases. Therefore, the workability is deteriorated and the joint strength is also reduced, whereby the Al content is preferably 3.00% or less. The upper limit of the Al content is more preferably 1.2% from the viewpoint of securing the workability.

### N: 0.0100% or Less

N is an element that enhances the strength of the steel sheet, but forms a coarse nitride in the steel to deteriorate the formability of the steel. When the N content is more than 0.0100%, the deterioration of the formability of the steel and the reduction of the joint strength become significant, and thus the N content is desirably 0.0100% or less.

From the viewpoint of enhancing the cleanliness of the steel sheet, the N content may be 0%. The lower limit value of the N content may be 0.0001% from the viewpoint of manufacturing cost for reducing N.

### Ti: 0.70% or Less

Ti is an element that forms a precipitate and makes the structure of the steel sheet into fine grains, and may be contained. In order to obtain a containing effect, the amount of Ti contained is preferably 0.001% or more. The T content is more preferably 0.01% or more. Meanwhile, if T is excessively contained, not only the manufacturability is lowered and cracking occurs during processing but also the joint strength is lowered, and thus the upper limit of the T content is preferably 0.70%, and more preferably 0.50% or less.

### Nb: 0.70% or Less

Nb is an element that forms a fine carbonitride and suppresses the coarsening of crystal grains, and may be contained. In order to obtain a containing effect, the amount of Nb contained is preferably 0.001% or more. The Nb content is more preferably 0.01% or more. The upper limit of the Nb content is preferably set to 0.70%, more preferably 0.50% or less, or 0.30% or less because the excessively contained Nb inhibits toughness to cause difficult manufacturing, and also causes a decrease in the joint strength.

### V: 0.30% or Less

V is an element that forms a fine carbonitride and suppresses the coarsening of crystal grains, and may be contained. In order to obtain a containing effect, the amount of V contained is preferably 0.001% or more. The V content is more preferably 0.03% or more. The upper limit of the V content is preferably set to 0.30%, and more preferably 0.25% or less because the excessively contained V inhibits toughness to cause difficult manufacturing, and also causes a decrease in the joint strength.

### Cr: 5.00% or Less

### Mo: 2.00% or Less

Cr and Mo are elements that contribute to the improvement of the strength of steel, and may be contained. In order to obtain a containing effect, the amounts of Cr and Mo contained are preferably 0.001% or more. The Cr and Mo contents are more preferably 0.05% or more, respectively. However, when the Cr content is more than 5.00% or the Mo content is more than 2.00%, not only problems may occur during pickling or hot working, but also the joint strength is reduced. Therefore, the upper limit of the Cr content is preferably set to 5.00%, and the upper limit of the Mo content is preferably set to 2.00%.

### Cu: 2.00% or Less

### Ni: 10.00% or Less

Cu and Ni are elements that contribute to the improvement of the strength of steel, and may be contained. In order to obtain a containing effect, the amounts of Cu and Ni contained are preferably 0.001% or more, respectively. The Cu and Ni contents are more preferably 0.10% or more. However, when the Cu content is more than 2.00% and the Ni content is more than 10.00%, not only problems may occur during pickling or hot working, but also the joint strength may be reduced. Therefore, the upper limit of the Cu content is preferably 2.00%, and the upper limit of the Ni content is preferably 10.00%.

### Ca: 0.0030% or Less

### REM: 0.050% or Less

### Mg: 0.05% or Less

### Zr: 0.05% or Less

Ca, a rare earth metal (REM), Mg, and Zr are elements that contribute to the refinement of oxides after deoxidation and sulfides present in a hot-rolled steel sheet to improve formability, and may be contained. However, when the content of Ca is more than 0.0030%, the content of REM is more than 0.050%, and the content of Mg or Zr is more than 0.05%, the workability of the steel is deteriorated. Therefore, the upper limit of the Ca content is preferably 0.0030%, the upper limit of the REM content is preferably 0.050%, and the upper limit of each of the contents of Mg and Zr is preferably 0.05%.

In order to obtain a containing effect, the Ca content is preferably 0.0005% or more, the REM content is preferably 0.001% or more, the Mg content is preferably 0.001% or more, and the Zr content is preferably 0.001% or more.

“REM” is a generic term for total 17 elements of Sc, Y, and lanthanoid, and the REM content refers to the total content of one or two or more elements of the REM. The REM is generally contained in misch metal. Therefore, for example, the REM may be contained in the form of misch metal so that the total content of the REM falls within the above range.

### B: 0.0200% or Less

B is an element that segregates at a grain boundary to increase grain boundary strength, and may be contained. In order to obtain a containing effect, the amount of B contained is preferably 0.0001% or more, and more preferably 0.0008% or more. Meanwhile, the upper limit of the B content is preferably set to 0.0200%, and more preferably 0.010% or less because the excessively contained B inhibits toughness to cause difficult manufacturing, and also causes a decrease in joint strength.

In the welded joint according to the present disclosure, at least one steel sheet in a sheet set in which two or more steel sheets are overlapped has a C content of 0.280% by mass or more and 0.700% by mass or less, and a steel sheet having a composition within the range described above is used by selecting a desired element from the above-described elements.

The steel sheet may contain:
C: 0.280% to 0.700%,
Si: more than 0.10%,
Mn: 15.00% or less,
P: less than 0.010%,
S: 0.0100% or less,
Al: 3.00% or less,
N: 0.0100% or less, and

the balance composed of iron (Fe) and impurities.

The steel sheet having the above composition may contain, in place of a part of the iron (Fe), one or two or more elements selected from the group consisting of:
Ti: 0.70% or less,
Nb: 0.70% or less,
V: 0.30% or less,
Cr: 5.00% or less,
Mo: 2.00% or less,
Cu: 2.00% or less,
Ni: 10.00% or less,
Ca: 0.0030% or less,
REM: 0.050% or less,
Mg: 0.05% or less,
Zr: 0.05% or less, and
B: 0.0200% or less.

The C content of all the steel sheets constituting the sheet set may be 0.280% or more and 0.700% or less, and the C contents in some of the steel sheets of the sheet set may be less than 0.280% or more than 0.700%.

The sheet thickness of each steel sheet constituting the sheet set is not particularly limited, and for example, a sheet thickness of 0.5 to 3.5 mm is exemplified.

The total thickness t of the sheet set is also not particularly limited, and is, for example, 1.5 to 8.0 mm.

The application of the welded joint according to the present disclosure is also not particularly limited, but for example, the welded joint is considered to be particularly effective for vehicle body components.

### [Method of Manufacturing Spot Welded Joint]

The method of manufacturing a spot welded joint according to the present disclosure is not particularly limited, and examples thereof include a method in which a sheet set in which two or more steel sheets including at least one steel sheet having a C content of 0.280% or more and 0.700% or less are overlapped is subjected to first energization, first non-energization, and second energization at a specific current value for a specific time, and then tempering under a specific condition at the energized position after the elapse of a predetermined time t_{c2} (ms). According to such a method, CTS can be significantly improved as compared with a case where resistance spot welding is performed by single energization, and the spot welded joint according to the present disclosure can be suitably manufactured. Hereinafter, an example of a preferred method of manufacturing a spot welded joint according to the present disclosure (may be referred to as “a method of manufacturing a spot welded joint according to the present disclosure”) will be described in detail.

That is, a method of manufacturing a spot welded joint (in the present disclosure, may be simply referred to as a “method of manufacturing a welded joint”) according to the present disclosure includes:
a first non-energization step of non-energizing the sheet set for a time t_{c1} of 20 ms or more and 200 ms or less after the first energization step;
a second energization step of energizing the sheet set at a current value I₂ (kA) satisfying the following formula (1) for a time t₂ (ms) satisfying the following formula (2), after the first non-energization step:

$$0.6 \leq {I}_{2} / {I}_{1} \leq 1.1 \qquad ( 1 )$$

$$50 \leq {t}_{2} \leq 1000 ; \qquad ( 2 )$$

and
a tempering step of performing tempering under a condition that a tempering temperature is 350° C. or higher and a tempering parameter H calculated according to the following formula (A) is 8000 or more and 18000 or less at the energized position after the elapse of a time t_{c2} (ms) satisfying the following formula (3), after the second energization step:

$${t}_{c 2} > 3.5 \times {10}^{- 3} \times {Ms}^{2} - 3.3 \times Ms + 1100 \qquad ( 3 )$$

$$H = T \times ( log {t}_{HT} + ( 17.7 - 5.8 \times [ C ] ) ) . \qquad ( A )$$

Ms in the formula (3) means an Ms point calculated by substituting % by mass of each element contained in the steel sheet constituting the sheet set into an element symbol in the following formula (4). In a case in which all the steel sheets constituting the sheet set do not have the same composition, an Ms point of a weighted average of values obtained by multiplying the Ms point calculated for each steel sheet according to the formula (4) for all the steel sheets constituting the sheet set by a sheet thickness ratio of each steel sheet with respect to a total thickness of the sheet set is substituted into the formula (3).

$$Ms ( ° C . ) = 561 - 474 \times C - 33 \times Mn - 17 \times Ni - 17 \times Cr - 21 \times Mo \qquad ( 4 )$$

T in the formula (A) means a tempering temperature (K) in a vicinity of a nugget end portion formed by the energization; t_{HT} means a tempering time (s); and [C] means a C content (% by mass) in a steel sheet having a highest C content in the sheet set.

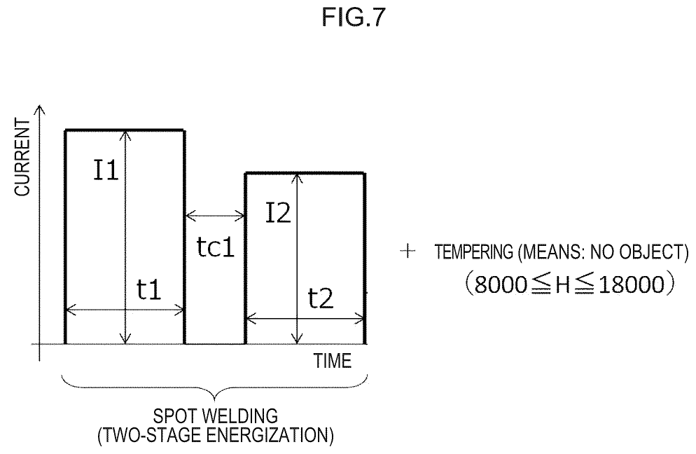

FIG. 7 is a view schematically illustrating spot welding (current and time) and tempering in the method of manufacturing a spot welded joint according to the present disclosure. A method of manufacturing a welded joint according to the present disclosure includes subjecting a sheet set in which two or more steel sheets including at least one steel sheet having a C content of 0.280% by mass or more and 0.700% by mass or less are overlapped to a first energization step, a first non-energization step, and a second energization step as illustrated in FIG. 7, and then subjecting the sheet set to a tempering step so that a tempering temperature is 350° C. or higher and a tempering parameter H is within a range of 8000 to 18000, thereby remarkably improving joint strength. Hereinafter, each of the steps will be specifically described. The components of the steel sheet to be used will be described later.

### [First Energization Step]

First, as the first energization step, a sheet set in which two or more steel sheets including at least one steel sheet having a C content of 0.280% by mass or more and 0.700% by mass or less are overlapped is energized at a current value I₁ (kA) while being clamped and pressurized in a sheet thickness direction between a pair of electrodes.

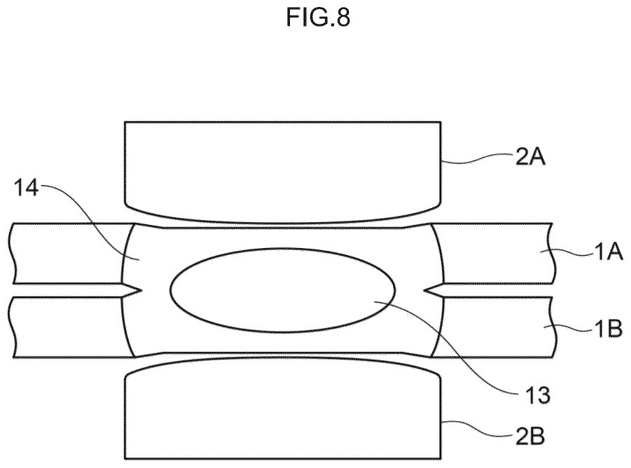

In the first energization step, it is preferable to set the current value I₁ (kA) and an energization time t₁ (ms) so that a nugget joining all the steel sheets constituting the sheet set is formed by spot welding. FIG. 8 schematically illustrates an example of a nugget formed when a sheet set in which two steel sheets overlap is subjected to the first energization step. As illustrated in FIG. 8, energization is performed between an electrode 2A and an electrode 2B while the electrodes 2A and 2B are pressed so as to clamp a sheet set in which steel sheets 1A and 1B overlap in the sheet thickness direction. As a result, a nugget 13 and a heat-affected zone (so-called HAZ) 14 are formed in an energized portion between the steel sheet 1A and the steel sheet 1B, and both the steel sheets are spot welded.

As the current value I₁ in the first energization step, a current value at which a desired nugget diameter is obtained is used, and in a case in which the thickness of half of the total sheet thickness is t (mm), the energization time t₁ may be set to 10t−5 to 10t+5 cycle (50 Hz) or the like. The nugget diameter is preferably set to 4\sqrt{ }t or more from the viewpoint of joint strength and avoidance of scattering. The nugget diameter is more desirably 5\sqrt{ }t or more. In order to form such a nugget diameter of 5\sqrt{ }t or more without causing scattering, it is desirable to set an up-slope before the first energization step. Pre-energization may be performed at a current value lower than that in the first energization step before the first energization step.

The pressurizing force of the electrodes 2A and 2B to the sheet set is, for example, 2000 to 8000 N so as to suppress the occurrence of scattering and to stably obtain the nugget. The pressurizing force may be constant or may be changed on the way. If there is a fluctuation in the pressurizing force before two-stage energization, the grain growth is hindered and the effect margin of grain size regulation may be reduced, and thus, in the first energization step, the first non-energization step, and the second energization step, the fluctuation in the pressurizing force by both the electrodes 2A and 2B with respect to the sheet set is preferably small. The pressurizing force in the first non-energization step with respect to the pressurizing force P in the first energization step is preferably 0.8 P to 1.2 P, and the pressurizing force in the second energization step is preferably 0.8 P to 1.2 P. In the first energization step, the first non-energization step, and the second energization step, the pressurizing force by both the electrodes 2A and 2B to the sheet set is more preferably constant.

Pre-energization may be performed before upslope or nugget formation. Downslope or the like may be included. The nugget may be formed by pulse energization.

### [First Non-Energization Step]

After the first energization step, non-energization is performed for a time t_{c1} of 20 ms or more and 200 ms or less.

When the non-energization time t_{c1} is less than 20 ms, the nugget end portion may not be solidified before the second energization step. Meanwhile, when the non-energization time t_{c1} is more than 200 ms, the nugget end portion may be excessively solidified before the second energization step.

In order to avoid post-energization (second energization step) in a state where the solidification of the nugget end portion is insufficient or the nugget end portion is excessively solidified, to appropriately advance the solidification of the nugget end portion (in order to avoid performing the second energization before the nugget end portion is solidified or after the nugget end portion is excessively solidified), the non-energization time t_{c1} after the first energization step is set to 20 ms or more and 200 ms or less, preferably 25 ms or more and 160 ms or less, and more preferably 30 ms or more and 150 ms or less.

### [Second Energization Step]

The second energization step is an important step in which the present inventors have found that CTS can be improved even when the amount of C in the steel sheet is 0.280% or more. The grain sizes in the vicinity of the melting boundary in the nugget are effectively regulated to improve the toughness of a portion where a stress applied in a peeling direction is the highest in the CTS test.

After the first non-energization step, energization is performed at a current value I₂ (kA) satisfying the following formula (1) for a time t₂ (ms) satisfying the following formula (2).

$$0.6 \leq {I}_{2} / {I}_{1} \leq 1.1 \qquad ( 1 )$$

$$50 \leq {t}_{2} \leq 1000 ; \qquad ( 2 )$$

In the second energization step, the energization is performed under the condition that the ratio (I₂/I₁) of the current value (I₂) to the current value (I₁) in the first energization step and the energization time (t₂) respectively satisfy the above formulas (1) and (2) in order to melt the nugget central portion to appropriately apply heat to the vicinity of the nugget end portion without exceeding the melting boundary formed in the first energization step.

The second energization step corresponds to a crystal grain control heat treatment, and energization is performed at the current value I₂ (kA) for the time t₂ (ms) satisfying the above formulas (1) and (2), whereby the crystal grains of the nugget change, and the joint strength can be improved.

I₂/I₁ is preferably 0.75 to 1.05, and t₂ is preferably 200 to 600.

### [Tempering Step]

After the second energization step, tempering is performed at the energized position.

### Time: t_{c2}

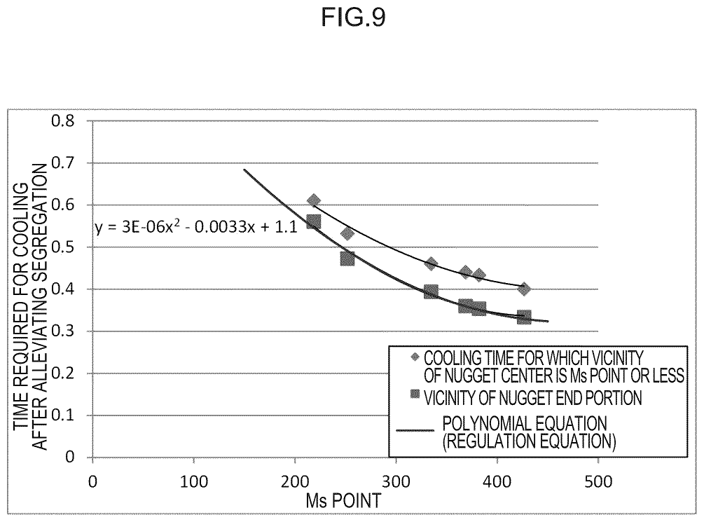

In the tempering step, in order to temper the nugget formed by the first energization and the second energization, the temperature of the entire welded portion (nugget) needs to be the Ms point or lower after the second energization step before the tempering. Thus, the required time varies depending on the steel components. FIG. 9 illustrates a time required for cooling to Ms obtained by calculation. When the Ms point is obtained by the above formula (4) and the time (cooling time) t_{c2} required for the temperature of the entire welded portion to be the Ms point or lower is calculated, the following formula (3) needs to be satisfied.

$${t}_{c 2} > 3.5 \times {10}^{- 3} \times {Ms}^{2} - 3.3 \times Ms + 1100 \qquad ( 3 )$$

Ms in the formula (3) means an Ms point calculated by substituting % by mass of each element contained in the steel sheet constituting the sheet set into the element symbol in the following formula (4).

$$Ms ( ° C . ) = 561 - 474 \times C - 33 \times Mn - 17 \times Ni - 17 \times Cr - 21 \times Mo \qquad ( 4 )$$

Among the elements in the formula (4), zero is substituted into the corresponding element symbol for an element not included in the steel sheet. When all the steel sheets constituting the sheet set do not have the same composition, in consideration of the sheet thickness, the Ms point of the weighted average of values obtained by multiplying the sheet thickness ratio of each steel sheet with respect to the total thickness of the sheet set (entire thickness) to the Ms point calculated for each steel sheet according to the formula (4) for all the steel sheets constituting the sheet set is substituted into the formula (3).

For example, in the case of a sheet set in which three steel sheets α, β, and γ having different compositions overlap, assuming that the Ms points (° C.) calculated from the compositions of the respective steel sheets according to the formula (4) are respectively Ms_{α}, Ms_{β}, and Ms_{γ}, the sheet thicknesses (mm) of the respective steel sheets are respectively t_{α}, t_{β}, and t_{γ}, and the total thickness of the sheet set is t, the Ms point (MSₐᵥₑ) of the weighted average in consideration of the sheet thickness of each steel sheet in this sheet set is calculated as follows.

$${M}_{Save} = {Ms}_{α} \times ( {t}_{α} / t ) + {Ms}_{β} \times ( {t}_{β} / t ) + {Ms}_{γ} \times ( {t}_{γ} / t )$$

If the cooling time t_{c2} is too long, fatigue strength in cross tension may be lowered even if the tempering is performed. For this reason, even if tempering is performed after cooling, a strong residual stress may remain in the welded portion. Therefore, the cooling time t_{c2} is preferably 9000 ms or less.

### Tempering Parameter: H

At the position where the spot welding has been performed by the first energization and the second energization, the tempering is performed under the condition that the tempering temperature is 350° C. or higher and the tempering parameter H calculated according to the following formula (A) is 8000 or more and 18000 or less after the elapse of the time t_{c2} (ms) from the end of the second energization.

$$H = T \times ( log {t}_{HT} + ( 17.7 - 5.8 \times [ C ] ) ) \qquad ( A )$$

In the formula (A), T means a tempering temperature (K) in the vicinity of the nugget end portion formed by energization, t_{HT} means a tempering time (s), and [C] means a C content (% by mass) in the steel sheet. In the case of a sheet set obtained by combining steel sheets having different C contents, the C content (% by mass) in the steel sheet having the highest C content is adopted as [C].

In order to sufficiently advance the tempering, the tempering parameter H is set to 8000 or more, preferably 9000 or more, and more preferably 10,000 or more. Even if the tempering excessively proceeds, the carbide becomes too large and the toughness decreases, and thus the tempering parameter H is set to 18000 or less, and preferably 17000 or less.

When the tempering temperature T is too high, austenite is crystallized to cause requenching. Therefore, tempering is performed at a transformation point or lower. Therefore, the tempering temperature is preferably A_{c1} (° C.) or lower calculated according to the following formula (B), and more preferably (A_{c1}-30° C.) or lower.

$${A}_{c 1} = 750.8 - 26.6 C + 17.6 Si - 11.6 Mn - 22.9 Cu - 23 Ni + 24.1 Cr + 22.5 Mo - 39.7 V - 5.7 Ti + 232.4 Nb - 169.4 Al - 894.7 B \qquad ( B )$$

The content (% by mass) of each element contained in the steel sheet is substituted into the element symbol in the above formula, and zero is substituted into an element not contained in the steel sheet.

In the case of a sheet set that is not a combination of the same steel types (steel types having the same steel composition), the tempering temperature can be set based on A_{c1} of a weighted average by a sheet thickness, that is, A_{c1} of a weighted average of a value obtained by multiplying A_{c1} calculated according to the formula (B) for each of steel sheets for all the steel sheets constituting the sheet set by the sheet thickness ratio of each of the steel sheets with respect to the total thickness of the sheet set.

The tempering temperature T in the formula (A) for calculating the tempering parameter H is an absolute temperature (K), whereas A_{c1} calculated according to the formula (B) is a Celsius temperature (° C.). Therefore, for example, when the tempering temperature is set based on A_{c1} (° C.) calculated according to the formula (B) in the tempering step, the tempering temperature T (K) in the formula (A) is converted into an absolute temperature, and the tempering time t_{HT} (s) can be set so that the tempering parameter His within a predetermined range.

In the present disclosure, the tempering temperature T (K) is based on a temperature at an inner position (in the present disclosure, may be referred to as “the vicinity of the nugget end portion”) of 0.5 mm from the nugget end portion after the second energization step. Here, the “nugget end portion” is a portion that had been a sheet interface of the sheet set at the melting boundary of the nugget. In the case of tempering by a spot welding machine, it is difficult to directly measure the temperature in the vicinity of the nugget end portion, and thus, a temperature estimated by performing simulation by heat conduction analysis is used. For example, QuickSpot (Research Center of Computational Mechanics, Inc.) can be used as software for performing simulation by thermal conduction analysis. In Examples described later, in the case of the tempering by the spot welding machine, the temperature in the vicinity of the nugget end portion was calculated by simulation using the software described above. When a furnace or another heat source is used, a temperature in the vicinity of a temperature measuring unit may be substituted or a furnace temperature or the like may be used.

The tempering temperature T may vary depending on a tempering unit. In the present disclosure, the tempering parameter H is calculated as follows.

(1) The Case where the Temperature is Constant

When the tempering temperature in the tempering step is constant, each parameter is substituted into the formula (A) to calculate the tempering parameter H.

(2) The Case where the Temperature Stepwisely Changes

In the cases of times: temperatures
t_{HT0} to t_{HT1}: T₁ [K]
t_{HT1} to t_{HT2}: T₂ [K]
. . .
tHTₖ₋₁ to t_{HTK}: Tₖ [K],
the tempering parameter H₁ between t_{HT0} and t_{HT1} is calculated as

$${H}_{1} = {T}_{1} \times ( log ( {t}_{HT 1} - {t}_{HT 2} ) + ( 17.7 - 5.8 \times [ C ] ) ) .$$

When the time obtained at the temperature T₂ in the next section is t_{HT2}′, H₁=T₂×(log(t_{HT2}′)+(17.7−5.8×[C])) is set, and the tempering parameter H₁₊₂ at t_{HT0} to t_{HT2} up to the second section is H₁₊₂=T₂×(log(t_{HT2}−t_{HT1}+t_{HT2}′)+(17.7−5.8×[C])).

This is repeated, and H in all the sections is

$$H = {T}_{k} \times ( log ( {t}_{HT k} - {t}_{HTk - 1} + {t}_{HTk}^{′} ) + ( 17.7 - 5.8 \times [ C ] ) ) .$$

When the tempering temperature stepwisely changes, the tempering parameter H in the tempering step is calculated in this manner.

A temperature at which H obtained on the assumption that all the sections are isothermal is the same is referred to as a representative temperature.

(3) The Case where the Temperature Continuously Changes

A section in which a temperature change is within 50° C. is set, and the average of temperatures in the sections is Tₐᵥₑ, which is the representative temperature of the section. By this method, the sections tₐ to t_{b} are divided, and H is calculated by applying the method of “(2) the case where the temperature stepwisely changes”.

$${T}_{ave} = \frac{1}{( tb - ta )} {\int }_{ta}^{tb} T ( t ) dt \qquad [ Expression 1 ]$$

$$Ha = {T}_{ave} \times ( log ( {t}_{b} - {t}_{a} ) + ( 17.7 - 5.8 \times [ C ] ) )$$

is set. Then, t_{c} is obtained from the next section t_{b}, and Hs in all the sections are calculated by the same method as in (2). Similarly to (2), a temperature at which H obtained on the assumption that all the sections are isothermal is the same is referred to as a representative temperature.

The tempering method in the tempering step is not particularly limited as long as the tempering temperature is 350° C. or higher and the tempering parameter H calculated according to the formula (A) falls within the range of 8000 to 18000. After the second energization step, tempering may be performed by a spot welding machine as it is, or tempering may be performed by using a heat source other than the spot welding machine.

### <Tempering by Spot Welding Machine>

After the second energization, no energization is applied while pressurization is applied by electrodes, and energization is then performed again to perform tempering.

That is, after the second energization step, cooling is performed by non-energization for the time t_{c2} (ms) satisfying the above-described formula (3). Then, as the third energization step, energization is preferably performed at a current value I₃ (kA) satisfying the following formula (5) for a time t₃ (ms) satisfying the following formula (6).

$$0.4 \leq {I}_{3} / {I}_{1} \leq 1. \qquad ( 5 )$$

$$450 \leq {t}_{3} \qquad ( 6 )$$

The third energization step corresponds to a tempering heat treatment, and the nugget cooled to the Ms point or less is reheated at the current value I₃ for the energization time t₃ so that the tempering parameter H falls within the range of 8000 to 18000. As a result of the experiment, for the current value (I₃) in the third energization step, energization is performed under the condition that the ratio (I₃/I₁) of the current value (I₃) to the current value (I₁) in the first energization step and the energization time (t₃) respectively satisfy the formulas (5) and (6), so that the toughness can be effectively improved.

When the energization time in the third energization step is too long, productivity is lowered, and thus the energization time is preferably 5000 ms or less.

After the third energization step, it is preferable to provide a so-called holding time during which only pressurization is applied without energization.

As described above, when the tempering is performed by performing the non-energization and the energization while the sheet set is pressurized by the electrodes following the second energization step, the first energization step to the tempering step can be continuously performed, and the work efficiency and the productivity can be improved.

After the second energization, the electrodes are temporarily separated from the sheet set. After the elapse of the time t_{c2}, the energization may be performed again using a spot welding machine under the same conditions as in the third energization step to perform the tempering.

<Tempering by Heat Source Other than Spot Welding Machine>

The tempering may be performed by a heat source other than the spot welding machine. That is, after the second energization, the electrodes are separated from the sheet set, and the nugget is heated using the heat source other than the spot welding machine after the elapse of the time t_{c2} satisfying the formula (3). The heat source (heating means) other than the spot welding machine is not particularly limited, and examples thereof include a furnace, a laser, a burning iron, a hot plate, and high-frequency induction heating. Heating is performed so that the tempering parameter H falls within the range of 8000 to 18000 regardless of which heating means is used.

The use of the heating means other than the spot welding machine as the heat source for tempering is advantageous in that the variation in the tempering temperature is reduced as compared with tempering by energization using the spot welding machine. In the case of using the spot welding machine, there are a flow of heat to a steel material present in the vicinity, and a branch flow to another welding point, and the like, which makes it necessary to set a current value incorporating the flow. Meanwhile, since the heating means as described above has few influence factors and easily provides a target temperature, the heating means advantageously has high robustness and small labor for obtaining high joint strength.

In the method of manufacturing a welded joint according to the present disclosure, at least one of the steel sheets constituting the sheet set may have a C content of 0.280% by mass or more and 0.700% by mass or less. The number of the steel sheets constituting the sheet set is not particularly limited as long as it is two or more, and may be selected according to the application of the welded joint to be manufactured. Any element other than C, the sheet thickness, and the total thickness t of the sheet set, and the like are also as described above with respect to the welded joint, and the description thereof is omitted here.

A sheet set in which two or more steel sheets including at least one steel sheet having a C content of 0.280% or more and 0.700% or less overlap is subjected to resistance spot welding including the above-described respective steps, and tempering, so that CTS can be greatly improved as compared with a case where resistance spot welding by single energization is performed.

The field to which such a method of manufacturing a welded joint according to the present disclosure is applied is not particularly limited, but for example, the method is considered to be particularly effective for steps such as assembly of vehicle bodies and attachment of components.

Through the above steps, it is possible to manufacture the welded joint according to the present disclosure, that is, the spot welded joint in which the average of the ratios of the major axes to the minor axes (major axes/minor axes) of the prior austenite grains in the melting boundary region, which is up to 1 mm inside a melting boundary of the nugget end portion corresponding to a portion that had been a sheet interface, is in the range of 1.0 to 1.5, and the number density of the iron-based carbides having the equivalent circle diameter of 30 nm or more in the melting boundary region is 3.0×10⁶×C or more per 1 mm².

In Patent Document 3, tempering is performed at a relatively low temperature (220° C. or lower), and it is considered that the number density of carbides of 30 nm or more is not sufficient even if the number density of carbides of 5 nm or more is 2×10⁶/mm² or more. The fine precipitation of the carbides causes hard welding, and the joint strength is hardly increased. Further, as illustrated in Examples described later, the following (A) to (D) were found.
(A) Even a high-strength steel sheet having tensile strength TS (MPa) of 1800×[C]+250 or more with respect to the amount of carbon can improve CTS, and by use of the steel sheet having tensile strength TS (MPa) of 1800×[C]+250 or more with respect to the amount of carbon, an effect of improving toughness can be expected in addition to the effect of improving CTS.
(B) When the holding time t_{c2} is 9000 msec or less, the residual stress decreases and the CTS improvement rate increases.
(C) In the HAZ, when the carbide precipitation density within 500 μm from the nugget end portion is 1.0×10⁶×C or more per 1 mm², the variation in CTS is reduced.
(D) When a steel sheet having a C content of more than 0.30% is used, the effect of improving CTS is enhanced.

### EXAMPLES

Hereinafter, a welded joint and a method of manufacturing a welded joint according to the present disclosure will be described with reference to Examples. The welded joint and the method of manufacturing the welded joint according to the present disclosure are not limited to these Examples.

Steel sheets having compositions shown in Table 1 were prepared, and subjected to resistance spot welding under conditions shown in Table 2 (sheet set, pressurizing force, and energization condition and the like) and tempering under conditions shown in Table 3.

TABLE 1

| | Sheet | Amount | Amount | Amount | Other | |
|---|---|---|---|---|---|---|
| Steel | thickness | of C | of Si | of Mn | [mass %: | Ms |
| sheet | [mm] | [mass %] | [mass %] | [mass %] | element] | [° C.] |
| a | 1.5 | 0.280 | 0.55 | 2.90 | — | 333 |
| b | 1.6 | 0.130 | 0.56 | 3.80 | — | 374 |
| c | 1.0 | 0.372 | 1.44 | 10.55 | — | 37 |
| d | 0.8 | 0.330 | 1.20 | 3.67 | — | 283 |
| e | 1.8 | 0.687 | 0.70 | 1.25 | — | 194 |
| f | 2.0 | 0.542 | 0.88 | 1.22 | — | 264 |
| g | 1.6 | 0.713 | 0.55 | 0.89 | — | 194 |
| h | 2.2 | 0.562 | 0.24 | 0.78 | — | 269 |
| i | 1.8 | 0.325 | 4.70 | 2.56 | — | 322 |
| k | 1.5 | 0.003 | 0.10 | 1.20 | — | 520 |
| l | 1.0 | 0.082 | 0.48 | 0.22 | — | 515 |
| m | 1.4 | 0.470 | 0.00 | 0.00 | — | 338 |
| n | 1.2 | 0.570 | — | — | 4.3: Ni, 0.5: Cr, | 186 |
| | | | | | 1.1: Mo, 0.3: Cu | |
| o | 1.2 | 0.460 | — | — | 0.4: V, 0.8: Al, | 343 |
| | | | | | 0.0003: B, 0.02: Nb, | |
| | | | | | 0.02: Ti | |

In Table 1, although P, S, and N were not intentionally added, component analysis of them was performed, and the amounts of P, S, and N were respectively less than 0.010%, 0.0100% or less, and 0.0100% or less. The balance is Fe and impurities. In Table 1, the values of the C contents of less than 0.280% or more than 0.700% in the steel sheets were underlined. The underlines in Table 2 mean that the requirements of the present disclosure are not satisfied. However, although steel sheets k and l have a C content of less than 0.280%, the steel sheets k and l are prepared for use in sheet sets of Invention Examples in which the steel sheets are combined with a steel sheet having a C content of 0.280% or more and 0.700% or less, and the steel sheets k and l are not underlined in “combination of steel sheets” in Table 2. The underlines in Table 3 mean that the requirements of the present disclosure are not satisfied. “CTS only in the first energization step” means CTS in a case where a sample is produced only by first energization (I₁, t₁) among energization conditions, and may be hereinafter referred to as “single energization CTS”.

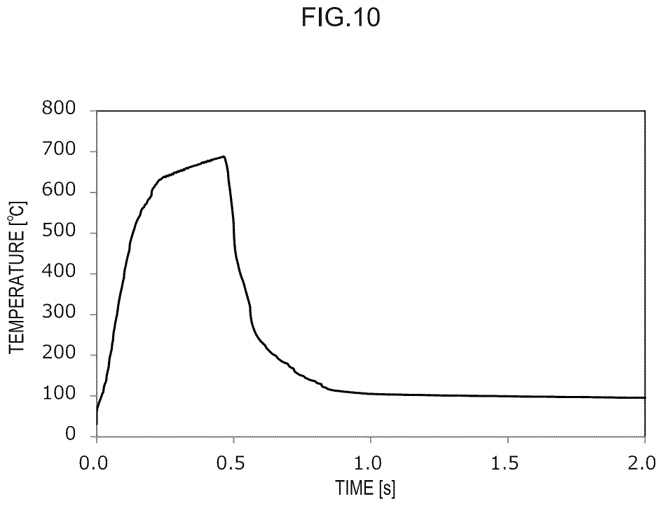

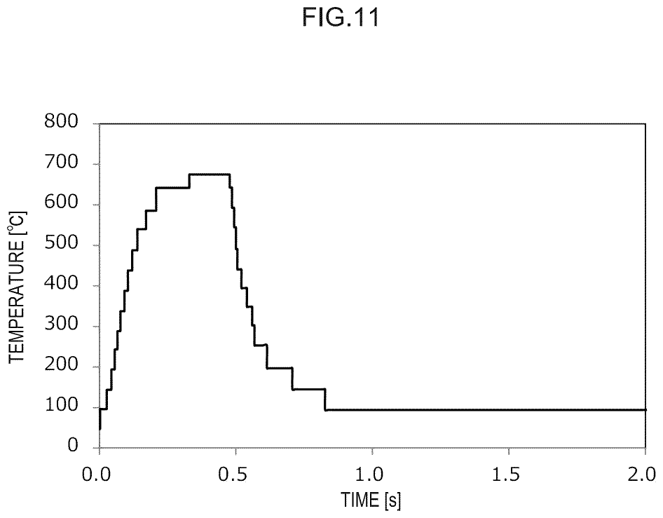

Calculation of a tempering parameter H in a case in which a tempering temperature changes with time will be described with reference to No. 9 in Table 3 in which tempering was performed by spot welding as an example. As a result of estimating a temperature history in the vicinity of a nugget end portion by thermal conduction analysis as a tempering step by spot welding, the temperature history illustrated in FIG. 10 was obtained. An average temperature was calculated in a range in which a temperature change did not exceed 50° C. FIG. 11 illustrates an average temperature change when a temperature was divided into a range not exceeding 50° C. In the section, the tempering parameter H was obtained by the method of “(3) the case where the temperature continuously changes” described above.

A rate of increase calculated according to the following formula was obtained as compared with the single energization CTS, and CTS having a rate of increase of more than 15% was determined as having an effect of improving joint strength.

$$Rate of increase [ \% ] = [ ( CTS under energization conditions of the present disclosure - single energization CTS ) / single energization CTS ] \times 100$$

TABLE 2

| | Combination of steel sheets | | | | Weighted | Weighted | Electrode |
|---|---|---|---|---|---|---|---|
| | First | Second | Third | Amount of | average | average | pressuring |
| | steel | steel | steel | carbon * | Ms | Ac1 | force |
| Number | sheet | sheet | sheet | [mass %] | [° C.] | [° C.] | [N] |
| 1 | a | a | — | 0.280 | 333 | 719 | 4000 |
| 2 | b | b | — | 0.130 | 374 | 713 | 4500 |
| 3 | c | c | — | 0.372 | 37 | 644 | 4000 |
| 4 | d | d | — | 0.330 | 238 | 721 | 4000 |
| 5 | e | e | — | 0.687 | 194 | 730 | 4000 |
| 6 | f | f | — | 0.542 | 264 | 738 | 4000 |
| 7 | g | g | — | 0.713 | 194 | 731 | 4000 |
| 8 | h | h | — | 0.562 | 269 | 731 | 4000 |
| 9 | i | i | — | 0.325 | 322 | 795 | 5000 |
| 11 | a | a | k | 0.280 | 395 | 726 | 4000 |
| 14 | a | a | — | 0.280 | 333 | 719 | 4000 |
| 15 | m | m | — | 0.470 | 338 | 738 | 3500 |
| 16 | n | n | — | 0.570 | 186 | 667 | 3500 |
| 17 | 0 | 0 | — | 0.460 | 343 | 591 | 3500 |
| 18 | a | a | — | 0.280 | 333 | 719 | 4000 |
| 19 | a | a | — | 0.280 | 333 | 719 | 4000 |
| 20 | c | l | c | 0.372 | 196 | 681 | 4000 |
| 21 | a | a | — | 0.280 | 333 | 719 | 4000 |
| 22 | a | a | — | 0.280 | 333 | 719 | 4000 |
| 23 | a | a | — | 0.280 | 333 | 719 | 4000 |
| 25 | a | a | — | 0.280 | 333 | 719 | 4000 |
| 26 | a | a | — | 0.280 | 333 | 719 | 4000 |
| 27 | a | a | — | 0.280 | 333 | 719 | 4000 |
| 28 | a | a | — | 0.280 | 333 | 719 | 4000 |
| 30 | a | a | — | 0.280 | 333 | 719 | 4000 |

| | | | First non- | | | | |
|---|---|---|---|---|---|---|---|
| | First energization | | energization | Second energization | | | Time until |
| | step | | step | step | | | tempering step |
| | I₁ | t₁ | t_{c1} | I₂ | t₂ | I₂/ | after second |
| Number | [kA] | [ms] | [ms] | [kA] | [ms] | I₁ | energization step |
| 1 | 7.3 | 400 | 50 | 5.8 | 500 | 0.80 | 1 day |
| 2 | 7.2 | 360 | 50 | 6.2 | 500 | 0.86 | 5 days |
| 3 | 6.9 | 300 | 50 | 6.3 | 500 | 0.91 | 5 minutes |
| 4 | 10.2 | 400 | 50 | 9.5 | 150 | 0.93 | 1 minute |
| 5 | 7.5 | 360 | 50 | 6.8 | 150 | 0.91 | 14 days |
| 6 | 6.8 | 300 | 80 | 4.2 | 150 | 0.62 | 1 day |
| 7 | 5.2 | 340 | 80 | 5.5 | 250 | 1.06 | 5 minutes |
| 8 | 7.8 | 340 | 100 | 6.2 | 250 | 0.79 | 5 hours |
| 9 | 8.1 | 250 | 80 | 6.6 | 700 | 0.81 | 30 seconds |
| 11 | 7.3 | 400 | 180 | 5.8 | 500 | 0.80 | 1800 seconds |
| 14 | 7.3 | 400 | 220 | 5.8 | 500 | 0.80 | 500 seconds |
| 15 | 8.2 | 340 | 50 | 6.6 | 700 | 0.80 | 500 seconds |
| 16 | 10.2 | 300 | 50 | 8.2 | 700 | 0.80 | 500 seconds |
| 17 | 8.2 | 300 | 50 | 6.6 | 700 | 0.80 | 500 seconds |
| 18 | 7.3 | 400 | 50 | 5.8 | 500 | 0.80 | 2.5 seconds |
| 19 | 7.3 | 400 | 10 | 5.8 | 500 | 0.80 | 500 seconds |
| 20 | 6.9 | 300 | 50 | 5.5 | 500 | 0.80 | 500 seconds |
| 21 | 7.3 | 400 | 50 | 5.8 | 500 | 0.80 | 500 seconds |
| 22 | 7.3 | 400 | 50 | 4.1 | 500 | 0.56 | 500 seconds |
| 23 | 7.3 | 400 | 50 | 8.5 | 500 | 1.16 | 500 seconds |
| 25 | 7.3 | 400 | 50 | 5.8 | 500 | 0.80 | 0.2 seconds |
| 26 | 7.3 | 400 | 50 | 5.8 | 500 | 0.80 | 500 seconds |
| 27 | 7.3 | 400 | 50 | 6.9 | 500 | 0.95 | 500 seconds |
| 28 | 7.3 | 400 | 50 | 6.9 | 500 | 0.95 | 500 seconds |
| 30 | 7.3 | 400 | 50 | 5.8 | 500 | 0.80 | 10 seconds |

* Maximum amount of carbon in case of sheet set in which amounts of carbon of steel sheets are different

TABLE 3

| | Tempering step | | | | | | | | |
|---|---|---|---|---|---|---|---|---|---|
| | | | Temperature at | | | Evaluation | | | |
| | | | 0.5 mm from | | | CTS only | | | |
| | | | nugget end or | | | in first | | | |
| | | | representative | | Tempering | energization | | Rate of | |
| | | Detailed | temperature | Time | parameter | step | CTS | increase | |
| Number | Method | conditions | [° C.] | [s] | H | [kN] | [kN] | [%] | Remarks |
| 1 | Air | — | 400 | 3000 | 13159 | 6.3 | 10.2 | 62 | Invention |
| | furnace | | | | | | | | Example |
| 2 | Air | — | 380 | 4500 | 13451 | 4.5 | 4.8 | 7 | Comparative |
| | furnace | | | | | | | | Example |
| 3 | Air | — | 350 | 300 | 11226 | 5.7 | 8.9 | 56 | Invention |
| | furnace | | | | | | | | Example |
| 4 | Air | — | 600 | 600 | 16207 | 4.3 | 9.5 | 121 | Invention |
| | furnace | | | | | | | | Example |
| 5 | Air | — | 450 | 30 | 10984 | 3.5 | 5.9 | 69 | Invention |
| | furnace | | | | | | | | Example |
| 6 | Hot plate | Plate for | 240 | 1800 | 9137 | 1.5 | 2.1 | 40 | Reference |
| | | cooking | | | | | | | Example |
| 7 | Air | — | 380 | 400 | 10557 | 0.9 | 0.8 | −11 | Comparative |
| | furnace | | | | | | | | Example |
| 8 | Air | — | 600 | 100 | 14352 | 1.8 | 2.9 | 61 | Invention |
| | furnace | | | | | | | | Example |
| 9 | Spot | Pressurization: | 614 | 2.0 | 14295 | 5.8 | 6.9 | 19 | Invention |
| | welding | 3000N, energization | | | | | | | Example |
| | | time: 0.8 s, current | | | | | | | |
| | | value: 5.3 kA | | | | | | | |
| 11 | Gas | — | 600 | 600 | 16460 | 1.8 | 2.1 | 17 | Invention |
| | furnace | | | | | | | | Example |
| 14 | Burning | Contact surface: | 400 | 3.0 | 11140 | 4.8 | 5.1 | 6 | Comparative |
| | iron | 10 × 30-mm iron | | | | | | | Example |
| 15 | Air | — | 450 | 80 | 12202 | 4.2 | 8.2 | 95 | Invention |
| | furnace | | | | | | | | Example |
| 16 | Hot plate | Plate for cooking | 220 | 2000 | 8724 | 3.2 | 5.8 | 81 | Reference |
| | | | | | | | | | Example |
| 17 | Air | — | 450 | 80 | 12244 | 2.8 | 5.2 | 86 | Invention |
| | furnace | | | | | | | | Example |
| 18 | Spot | Pressurization is | 630 | 0.8 | 14429 | 6.3 | 9.5 | 51 | Invention |
| | welding | reduced to 2000N | | | | | | | Example |
| | | after energization | | | | | | | |
| | | pause after second | | | | | | | |
| | | energization, | | | | | | | |
| | | energization time: | | | | | | | |
| | | 0.8 s, current value: | | | | | | | |
| | | 4.2 kA | | | | | | | |
| 19 | Burning | Contact surface: | 400 | 3.0 | 11140 | 4.8 | 5.0 | 4 | Comparative |
| | iron | 10 × 30-mm iron | | | | | | | Example |
| 20 | Burning | Contact surface: | 370 | 2.5 | 10250 | 10.8 | 13.5 | 25 | Invention |
| | iron | circular iron having | | | | | | | Example |
| | | radius of 10 mm | | | | | | | |
| 21 | Gas burner | — | 400 | 5.0 | 11290 | 5.6 | 7.9 | 41 | Invention |
| | | | | | | | | | Example |
| 22 | Air | — | 350 | 300 | 11559 | 6.3 | 6.3 | 0 | Comparative |
| | furnace | | | | | | | | Example |
| 23 | Air | — | 350 | 300 | 11559 | 6.3 | 6.8 | 8 | Comparative |
| | furnace | | | | | | | | Example |
| 25 | Air | — | 350 | 300 | 11559 | 6.2 | 6.1 | −2 | Comparative |
| | furnace | | | | | | | | Example |
| 26 | Seam | Electrode diameter: | 600 | 2.0 | 14297 | 5.6 | 7.9 | 41 | Invention |
| | welding | 400 mm, width: | | | | | | | Example |
| | machine | 8 mm, speed: | | | | | | | |
| | | 2 m/min, | | | | | | | |
| | | pressurization: | | | | | | | |
| | | 400 kgf, current | | | | | | | |
| | | value: 6 kA | | | | | | | |
| 27 | Air | — | 140 | 300 | 7662 | 6.3 | 7.1 | 13 | Comparative |
| | furnace | | | | | | | | Example |
| 28 | Air | — | 800 | 15 | 18511 | 6.4 | 6.8 | 6 | Comparative |
| | furnace | | | | | | | | Example |
| 30 | Spot | Pressurization: | 580 | 2.0 | 13970 | 6.2 | 9.3 | 50 | Invention |
| | welding | 3000N, energization | | | | | | | Example |
| | | time: 0.8 s, current | | | | | | | |
| | | value: 5.3 kA | | | | | | | |

In invention examples, a sheet set in which the C content of at least one steel sheet is 0.280% by mass or more and 0.700% by mass or less was subjected to resistance spot welding satisfying the conditions of the present disclosure, and the rate of increase in CTS exceeded 15% as compared with the case where resistance spot welding was performed by single energization. As shown in Table 2, for example, Nos. 21 to 30 use a sheet set in which two steel sheets a are overlapped, and a pressurizing force, a current, and a time in the first energization step are the same, but as shown in Table 3, there are some variations in “CTS only in the first energization step”. This is affected by a difference in an electrode holding time (hold time) and the like.

Meanwhile, in Comparative Examples, any one of the C content, spot welding, and tempering of all the steel sheets does not satisfy the conditions of the present disclosure, whereby the rate of increase in CTS was less than 15% as compared with the case where resistance spot welding was performed by single energization, and rather, CTS decreased in some cases.

In Nos. 6 and 16 (Reference Examples), a temperature in the vicinity of the nugget end portion in the tempering step was lower than 350° C., but by performing tempering for a relatively long time, the tempering parameter H fell within the range of 8000 or more and 18000 or less, and a joint having a rate of rise in CTS exceeding 15% was obtained.

Steel sheets having compositions shown in Table 4 were prepared, and subjected to resistance spot welding and tempering under conditions shown in Table 5 (sheet set, pressurizing force, and energization condition and the like).

TABLE 4

| | Sheet | Amount | Amount | Amount | Other | |
|---|---|---|---|---|---|---|
| Steel | thickness | of C | of Si | of Mn | [mass %: | Ms |
| sheet | [mm] | [mass %] | [mass %] | [mass %] | element] | [° C.] |
| A | 1.5 | 0.280 | 0.55 | 2.90 | — | 333 |
| B | 1.6 | 0.130 | 0.56 | 3.80 | — | 374 |
| C | 1.0 | 0.372 | 1.44 | 10.55 | — | 37 |
| D | 1.8 | 0.687 | 2.70 | 1.25 | — | 194 |
| E | 1.6 | 0.713 | 0.55 | 0.89 | — | 194 |
| F | 2.2 | 0.562 | 5.82 | 0.78 | — | 269 |
| G | 0.5 | 0.152 | 0.60 | 12.20 | — | 86 |
| H | 3.2 | 0.082 | 0.48 | 0.22 | — | 515 |
| I | 1.4 | 0.470 | 0.00 | 0.00 | — | 338 |
| J | 1.2 | 0.570 | 0.00 | 0.00 | 4.3: Ni, 0.5: Cr, | 186 |
| | | | | | 1.1: Mo, 0.3: Cu | |
| K | 1.2 | 0.460 | 0.00 | 0.00 | 0.4: V, 0.8: Al, | 343 |
| | | | | | 0.0003: B, 0.02: Nb, | |
| | | | | | 0.02: Ti | |

In Table 4, although P, S, and N were not intentionally added, component analysis of them was performed, and the amounts of P, S, and N were respectively less than 0.010%, 0.0100% or less, and 0.0100% or less. The balance is Fe and impurities. In Table 1, the values of the C contents of less than 0.280% or more than 0.700% in the steel sheets were underlined. The underlines in Table 5 mean that the requirements of the present disclosure are not satisfied. However, although a steel sheet H has a C content of less than 0.280%, the steel sheet H is prepared for use in sheet sets of Invention Example in which the steel sheet is combined with a steel sheet having a C content of 0.280% or more and 0.700% or less, and the steel sheet His not underlined in “combination of steel sheets” in Table 5.

The underlines in Table 5 mean that the requirements of the present disclosure are not satisfied. “CTS only in the first energization step” means CTS in a case where a sample is produced only by first energization (I₁, t₁) among energization conditions, and may be hereinafter referred to as “single energization CTS”.

The CTS was measured according to JIS Z 3137: 1999.

A rate of increase calculated according to the following formula was obtained as compared with the single energization CTS, and CTS having a rate of increase of more than 15% was determined as having an effect of improving joint strength.

$$Rate of increase [ \% ] = [ ( CTS under energization conditions of the present disclosure - single energization CTS ) / single energization CTS ] \times 100$$

TABLE 5

| | Combination of | | | Amount of | | | | | | First non- |
|---|---|---|---|---|---|---|---|---|---|---|
| | steel sheets | | | weighted | Weighted | Weighted | Electrode | First energization | | energization |
| | First | Second | Third | average | average | average | pressurizing | step | | step |
| | steel | steel | steel | carbon | Ms | Ac1 | force | I₁ | t₁ | t_{c1} |
| Number | sheet | sheet | sheet | [mass %] | [° C.] | [° C.] | [N] | [kA] | [ms] | [ms] |
| 101 | A | A | — | 0.280 | 333 | 719 | 3000 | 7.3 | 400 | 40 |
| 102 | A | A | — | 0.280 | 333 | 719 | 3000 | 7.3 | 400 | 40 |
| 103 | I | I | — | 0.470 | 338 | 738 | 4000 | 9.8 | 450 | 40 |
| 104 | J | J | — | 0.570 | 186 | 667 | 4500 | 6.9 | 450 | 80 |
| 105 | K | K | — | 0.460 | 343 | 591 | 4500 | 7.2 | 450 | 80 |
| 106 | B | B | — | 0.130 | 374 | 713 | 4500 | 7.2 | 360 | 40 |
| 107 | A | A | — | 0.280 | 333 | 719 | 3000 | 7.3 | 400 | 40 |
| 108 | C | C | — | 0.372 | 37 | 644 | 3000 | 6.9 | 300 | 40 |
| 109 | D | D | — | 0.687 | 194 | 766 | 4000 | 8.9 | 20-ms | 40 |
| | | | | | | | | | pause and | |
| | | | | | | | | | 40-ms | |
| | | | | | | | | | energization | |
| | | | | | | | | | are | |
| | | | | | | | | | repeated | |
| | | | | | | | | | 15 times | |
| 110 | D | D | — | 0.687 | 194 | 766 | 4000 | 8.9 | 20-ms | 40 |
| | | | | | | | | | pause and | |
| | | | | | | | | | 40-ms | |
| | | | | | | | | | energization | |
| | | | | | | | | | are | |
| | | | | | | | | | repeated | |
| | | | | | | | | | 15 times | |
| 111 | E | E | — | 0.713 | 194 | 731 | 4000 | 7.5 | 360 | 40 |
| 112 | F | F | — | 0.562 | 269 | 829 | 5000 | 6.8 | 300 | 80 |
| 114 | A | A | H | 0.178 | 427 | 738 | 3000 | 7.3 | 400 | 40 |
| 115 | A | H | A | 0.178 | 427 | 738 | 3000 | 7.3 | 400 | 40 |
| 116 | A | A | — | 0.280 | 333 | 719 | 3000 | 7.3 | 400 | 40 |
| 118 | A | A | — | 0.280 | 333 | 719 | 4000 | 7.3 | 400 | 220 |
| 119 | A | A | — | 0.280 | 333 | 719 | 4000 | 7.3 | 400 | 10 |
| 120 | A | A | — | 0.280 | 333 | 719 | 4000 | 7.3 | 400 | 50 |
| 121 | A | A | — | 0.280 | 333 | 719 | 4000 | 7.3 | 400 | 50 |
| 122 | A | A | — | 0.280 | 333 | 719 | 4000 | 7.3 | 400 | 50 |
| 124 | A | A | — | 0.280 | 333 | 719 | 4000 | 7.3 | 400 | 50 |
| 125 | A | A | — | 0.280 | 333 | 719 | 4000 | 7.3 | 400 | 50 |
| 126 | A | A | — | 0.280 | 333 | 719 | 4000 | 7.3 | 400 | 50 |

| | | | | | | Temperature at | | |
|---|---|---|---|---|---|---|---|---|
| | | | | | | 0.5 mm from | | |
| | | | | | | nugget end or | | |
| | Second energization step | | | Other step | | representative | | Tempering |
| | I₂ | t₂ | I₂/ | (tempering | | temperature | Time | parameter |
| Number | [kA] | [ms] | I₁ | step) | | [° C.] | [s] | H |
| 101 | 5.8 | 500 | 0.80 | Spot | Energization time: | 654 | 1.8 | 15139 |
| | | | | welding | 1.8 s, current value: | | | |
| | | | | | 4.3 kA while | | | |
| | | | | | pressurization is | | | |
| | | | | | maintained after | | | |
| | | | | | 600 ms from | | | |
| | | | | | energization pause | | | |
| | | | | | after second | | | |
| | | | | | energization | | | |
| 102 | 5.8 | 500 | 0.80 | Spot | Energization time: | 679 | 1.8 | 15547 |
| | | | | welding | 1.8 s, current value: | | | |
| | | | | | 4.6 kA while | | | |
| | | | | | pressurization is | | | |
| | | | | | maintained after | | | |
| | | | | | 9500 ms from | | | |
| | | | | | energization pause | | | |
| | | | | | after second | | | |
| | | | | | energization | | | |
| 103 | 8.6 | 250 | 0.88 | Spot | Energization time: | 730 | 1.3 | 15133 |
| | | | | welding | 1.3 s, current value: | | | |
| | | | | | 6.3 kA while | | | |
| | | | | | pressurization is | | | |
| | | | | | maintained after | | | |
| | | | | | 7000 ms from | | | |
| | | | | | energization pause | | | |
| | | | | | after second | | | |
| | | | | | energization | | | |
| 104 | 5.7 | 400 | 0.83 | Tempering in air furnace | | | 400 | 2000 |
| | | | | (400° C., 2000 s) | | | | |
| 105 | 6.5 | 400 | 0.90 | Tempering in air furnace | | | 400 | 3000 |
| | | | | (400° C., 3000 s) | | | | |
| 106 | 6.2 | 500 | 0.86 | Spot | Pressurization: | 592 | 0.5 | 14398 |
| | | | | welding | 3000N, energization | | | |
| | | | | | time: 0.5 s, current | | | |
| | | | | | value: 4.5 kA | | | |
| 107 | 5.8 | 500 | 0.80 | Tempering in air furnace | | | 180 | 20 |
| | | | | (180° C., 20 s) | | | | |
| 108 | 6.7 | 40-ms pause and | 0.97 | Tempering in air furnace | | | 380 | 3000 |
| | | 60-ms energization | | (380° C., 3000 s) | | | | |
| | | are repeated | | | | | | |
| | | 10 times | | | | | | |
| 109 | 9.5 | 150 | 1.07 | Tempering in air furnace | | | 600 | 3000 |
| | | | | (600° C., 3000 s) | | | | |
| 110 | 9.5 | 150 | 1.07 | Spot | Pressurization is | 615 | 0.8 | 12093 |
| | | | | welding | reduced to 2000N | | | |
| | | | | | after 7000 ms from | | | |
| | | | | | energization pause | | | |
| | | | | | after second | | | |
| | | | | | energization, | | | |
| | | | | | energization time: | | | |
| | | | | | 0.8 s, current value: | | | |
| | | | | | 3.4 kA | | | |
| 111 | 6.8 | 150 | 0.91 | Tempering in air furnace | | | 400 | 3000 |
| | | | | (400° C., 3000 s) | | | | |
| 112 | 4.2 | 150 | 0.62 | Hot | Plate for cooking | 355 | 500 | 10764 |
| | | | | plate | | | | |
| 114 | 5.8 | 500 | 0.80 | Spot | Pressurization: | 622 | 0.8 | 14831 |
| | | | | welding | 3000N, energization | | | |
| | | | | | time: 0.8 s, current | | | |
| | | | | | value: 5.3 kA | | | |
| 115 | 5.8 | 500 | 0.80 | Spot | Energization time: | 499 | 0.8 | 12793 |
| | | | | welding | 0.8 s, current value: | | | |
| | | | | | 4.9 kA while | | | |
| | | | | | pressurization is | | | |
| | | | | | maintained after 1 s | | | |
| | | | | | from energization | | | |
| | | | | | pause after second | | | |
| | | | | | energization | | | |
| 116 | 5.8 | 8000 | 0.80 | Tempering in gas furnace | | | 500 | 300 |
| | | | | (500° C., 300 s) | | | | |
| 118 | 5.8 | 500 | 0.80 | Burning | Contact surface | 400 | 3.0 | 11140 |
| | | | | iron | 10 × 30-mm iron | | | |
| 119 | 5.8 | 500 | 0.80 | Burning | Contact surface | 400 | 200 | 12368 |
| | | | | iron | 10 × 30-mm iron | | | |
| 120 | 5.8 | 500 | 0.80 | Gas | 50 s | 720 | 50 | 17651 |
| | | | | burner | | | | |
| 121 | 4.1 | 500 | 0.56 | Tempering in air furnace | | | 600 | 300 |
| | | | | (600° C., 300 s) | | | | |
| 122 | 8.5 | 500 | 1.16 | Tempering in air furnace | | | 600 | 300 |
| | | | | (600° C., 300 s) | | | | |
| 124 | 5.8 | 500 | 0.80 | Tempering in air furnace | | | 850 | 300 |
| | | | | (850° C., 300 s) | | | | |
| 125 | 5.8 | 500 | 0.80 | Seam | Electrode diameter: | 644 | 0.5 | 14466 |
| | | | | welding | 500 mm, width; 8 mm, | | | |
| | | | | machine | speed; 4 m/min, | | | |
| | | | | | pressurization: | | | |
| | | | | | 500 kgf, current | | | |
| | | | | | value: 7 kA | | | |

| | | | | | | |
|---|---|---|---|---|---|---|
| 126 | 6.9 | 500 | 0.95 | Tempering in air furnace | 600 | 300 |
| | | | | (600° C., 300 s) | | |

TABLE 6

| | Average of ratios | Number of iron-based | | | | | |
|---|---|---|---|---|---|---|---|
| | of major axes to | carbides having an | | CTS only | | | |
| | minor axes of | equivalent circle | | in first | | | |
| | prior austenite | diameter of 30 nm or | 3.0 × 10⁶ × C | energization | | Rate of | |
| | grains at nugget | more per 1 mm² of | (C: C mass % of | step | CTS | increase | |
| Number | end portion | nugget end portion | steel sheet) | [kN] | [kN] | [%] | Remarks |
| 101 | 1.2 | 9.1 × 10⁵ | 8.4E+05 | 6.3 | 10.2 | 62 | Invention |
| | | | | | | | Example |
| 102 | 1.2 | 9.3 × 10⁵ | 8.4E+05 | 6.3 | 11.3 | 79 | Invention |
| | | | | | | | Example |
| 103 | 1.4 | 5.8 × 10⁶ | 1.4E+06 | 4.7 | 9.5 | 102 | Invention |
| | | | | | | | Example |
| 104 | 1.3 | 2.8 × 10⁶ | 1.7E+06 | 3.5 | 5.8 | 66 | Invention |
| | | | | | | | Example |
| 105 | 1.5 | 1.8 × 10⁶ | 1.4E+06 | 3.7 | 5.4 | 46 | Invention |
| | | | | | | | Example |
| 106 | 1.3 | 4.5 × 10⁴ | 3.9E+05 | 7.9 | 8.1 | 3 | Comparative |
| | | | | | | | Example |
| 107 | 1.2 | 2.3 × 10⁴ | 8.4E+05 | 6.3 | 5.7 | −10 | Comparative |
| | | | | | | | Example |
| 108 | 1.5 | 5.1 × 10⁶ | 1.1E+06 | 5.7 | 8.9 | 56 | Invention |
| | | | | | | | Example |
| 109 | 1.4 | 9.8 × 10⁶ | 2.1E+06 | 5.9 | 9.5 | 61 | Invention |
| | | | | | | | Example |
| 110 | 1.4 | 2.7 × 10⁶ | 2.1E+06 | 5.9 | 7.9 | 34 | Invention |
| | | | | | | | Example |
| 111 | 1.3 | 4.9 × 10⁷ | 2.1E+06 | 0.9 | 0.8 | −11 | Comparative |
| | | | | | | | Example |
| 112 | 1.4 | 2.5 × 10⁶ | 1.7E+06 | 1.5 | 2.1 | 40 | Invention |
| | | | | | | | Example |
| 114 | 1.1 | 5.8 × 10⁵ | 5.3E+05 | 5.8 | 6.9 | 19 | Invention |
| | | | | | | | Example |
| 115 | 1.1 | 6.1 × 10⁵ | 5.3E+05 | 1.3 | 1.8 | 38 | Invention |
| | | | | | | | Example |
| 116 | 2.1 | 9.2 × 10⁵ | 8.4E+05 | 5.8 | 5.1 | −12 | Comparative |
| | | | | | | | Example |
| 118 | 1.9 | 9.2 × 10⁵ | 8.4E+05 | 4.8 | 5.1 | 6 | Comparative |
| | | | | | | | Example |
| 119 | 1.6 | 9.7 × 10⁵ | 8.4E+05 | 4.8 | 5.0 | 4 | Comparative |
| | | | | | | | Example |
| 120 | 1.2 | 1.8 × 10⁶ | 8.4E+05 | 5.6 | 7.9 | 41 | Invention |
| | | | | | | | Example |
| 121 | 1.7 | 2.8 × 10⁶ | 8.4E+05 | 6.3 | 6.3 | 0 | Comparative |
| | | | | | | | Example |
| 122 | 2.6 | 1.8 × 10⁶ | 8.4E+05 | 6.3 | 6.8 | 8 | Comparative |
| | | | | | | | Example |
| 124 | 2.1 | 8.1 × 10⁷ | 8.4E+05 | 6.2 | 5.2 | −16 | Comparative |
| | | | | | | | Example |
| 125 | 1.2 | 5.1 × 10⁷ | 8.4E+05 | 6.2 | 7.9 | 27 | Invention |
| | | | | | | | Example |
| 126 | 1.3 | 8.7 × 10⁵ | 8.4E+05 | 6.3 | 7.9 | 25 | Invention |
| | | | | | | | Example |

The “average of the ratios of the major axes to the minor axes of the prior austenite grains at the nugget end portion” and the “number of the iron-based carbides of 30 nm or more per 1 mm² at the nugget end portion” were measured by the methods described above.

Note that “E+” in the column of “3.0×10⁶×C” in Table 6 means the factorial of 10, and for example, “8.4E+05” means “8.4×10^{5”.}

In the invention examples, the sheet set in which the C content of at least one steel sheet was 0.280% by mass or more and 0.700% by mass or less was used, and subjected to resistance spot welding and tempering under the condition that the ratios (aspect ratios) of the major axes/minor axes of the prior austenite grains at the nugget end portion and the number density of the iron-based carbides were both within the range of the present disclosure, and the rate of increase in CTS exceeded 15% as compared with the case of performing resistance spot welding by single energization.

Meanwhile, in Comparative Examples, any one of the C content in the steel sheet, the ratio (aspect ratio) of the major axis/minor axis of the prior austenite grain at the nugget end portion, and the number density of the iron-based carbides was out of the range of the present disclosure, and the rate of increase in CTS as compared with the case where resistance spot welding was performed by single energization was less than 15%, and rather, CTS decreased in some cases.

### Examples A1 and A2

The sheet thickness of a steel sheet Q is 1.6 mm. Steel sheets Q1 and Q2 having different tensile strengths (TS) were obtained by spot welding a sheet set in which two steel sheets Q were overlapped, and subsequently changing tempering conditions.

A pressurizing force in spot welding was constant at 400 kgf, and a current value was 7.5 kA and an energization time was 360 ms in a first energization step, a first non-energization time was 80 ms, a current value was 7.0 kA and an energization time was 500 ms in a second energization step, and a temper energization was performed at a current value of 4.3 kA for an energization time of 1500 ms while pressurization was maintained after energization pause of 600 ms after second energization.

A joint thus obtained was subjected to a CTS test, and the fracture toughness value of a welded portion was measured. For the measurement, the methods described in “Recent Problems in Joining Techniques for Automobile Bodies and Countermeasure Techniques therefor—Part 1”, Nippon Steel Technical Report No. 393 (2012) and “Fracture Mechanic Consideration of Spot Welded Joint Cross Tensile Test (second report): Development of Method of Evaluating Fracture Toughness of Spot Welded Portion” (Nippon Steel Co., Ltd., Fuminori WATANABE, et al.) were used. Specifically, a miniature CTS specimen (W=2 mm, B=1 mm) was cut from a nugget end portion, a crack was introduced in advance, and a crack opening load was applied by using a wire. The toughness value was estimated based on the load at the time of fracture. The results are shown in Table 7. Standard TS is a value calculated by 1800×[C]+250.

In A2 (Comparative Example), TS with respect to the carbon amount is low. This is considered to be because a coarse carbide is formed. The toughness of the welded joint is considered to be lowered by the formation of this coarse carbide, and the CTS of only the first energization is lower than that of A1 (Invention Example).

Furthermore, although there is an effect of the second- and third-stage energizations applied for improving CTS, the width thereof is narrower than that of A1. This is considered to be because the coarse carbide remains even after the second energization and becomes further coarse by the subsequent tempering, and the toughness value is lower than that of A1.

As described above, it can be seen that a CTS-improving effect cannot be sufficiently obtained in a steel sheet that is not TS appropriate for the amount of carbon.

TABLE 7

| | Steel | | | | | | Toughness value |
|---|---|---|---|---|---|---|---|
| | sheet Q | | Tensile | CTS only | | Rate of | estimated |
| | amount | Standard | strength | in first | CTS after | increase of | from miniature |
| | of C | TS | TS | energization | tempering | CTS | CS |
| Number | [mass %] | [MPa] | [MPa] | [kN] | [kN] | [%] | [Jc] |
| A1 | 0.31 | 808 | 1432 | 4.5 | 6.2 | 38 | 34 kN/m |
| A2 | 0.31 | 808 | 759 | 2.7 | 3.1 | 15 | 14 kN/m |

### Examples B1 and B2

A sheet set obtained by overlapping two steel sheets C in Table 4 was spot welded. A pressurizing force was constant at 3000 N, and a current value was 7.0 kA for an energization time of 300 ms and a first non-energization time was 40 ms in a first energization, a current value was 6.20 kA and an energization time was 100 ms in a second energization, and a temper energization was performed at a current value of 4.0 kA for an energization time of 1000 ms while pressurization was maintained after energization pause of 600 ms (B1) or 9500 ms (B2) after second energization.

Joints B1 and B2 thus obtained were subjected to a CTS test. Furthermore, a residual stress was measured. As the measurement method, a method described in “Simulation of welding residual stresses in resistance spot welding, FE modeling and X-ray verification” JOURNAL OF MATERIALS PROCESSING TECHNOLOGY 205 (2008) 60-69 was used. Specifically, the residual stress was calculated with a Young's modulus and a Poisson's ratio as 200 GPa and 0.3 using a value of a diffraction angle 2θ between 95 degrees and 105 degrees with respect to a diameter of 2 mm (the central portion of the nugget diameter) as X-rays. The results are shown in Table 8. The threshold of the residual stress can be determined to be preferably less than 90 MPa.

When B1 and B2 were compared with each other, the residual stress in B1 was smaller, and a CTS improvement margin (improvement rate) was larger.

TABLE 8

| | | | CTS only | | Rate of |
|---|---|---|---|---|---|
| | Holding | Residual | in first | CTS after | increase |
| | time | stress | energization | tempering | of CTS |
| Number | [msec] | [MPa] | [kN] | [kN] | [%] |
| B1 | 600 | 61 | 5.5 | 7.9 | 44 |
| B2 | 9500 | 96 | 5.5 | 6.7 | 22 |

### Examples C1 to C7

In the HAZ, when the carbide precipitation density within 500 μm from the nugget end portion is 1.0×10⁶×C or more per 1 mm², the variation in CTS is reduced. Specifically, the nugget was cut in the thickness direction so as to pass through the central portion of the nugget, and the HAZ portion within 500 μm from the nugget end portion in the cross section was observed in an observation area of 0.25 mm². The method of measuring the number density of the coarse iron-based carbides in the HAZ portion is the same as the method of measuring the number density of the coarse iron-based carbides at the nugget end portion.

30 CTS values were evaluated by standard deviation in the case of assuming normal distribution. When the values were 0.20 kN or less, the variation was determined to be small. The results are shown in Tables 9 and 10.

TABLE 9

| | | | Temperature at 0.5 mm | | |
|---|---|---|---|---|---|
| | | | from nugget end or | Time | Tempering |
| | Tempering | | representative | t_{HT} | parameter |
| Number | method | Details of tempering method | temperature [° C.] | [s] | H |
| C1 | Spot | Pressurization: 4000N, energization | 480 | 0.8 | 11827 |
| | | time: 0.8 s, current value: 5.3 kA | | | |
| C2 | Furnace | Tempering in air furnace (370° C., | 380 | 2000 | 12475 |
| | | 2000 s) | | | |
| C3 | Laser | Semiconductor laser, output: 1.7 kW, | 520 | 0.5 | 12293 |
| | | speed: 0.5 m/min, rectangle beam | | | |
| | | (width: 15 mm) | | | |
| C4 | Burning iron | Contact surface: 10 × 30-mm iron | 450 | 10 | 12149 |
| C5 | Hot plate | 360° C., 2000 s | 360 | 2000 | 12093 |
| C6 | Electron beam | Accelerating voltage: 50 kV, output: | 580 | 0.1 | 12627 |
| | | 10 kW, speed: 3 m/min | | | |
| C7 | High-frequency- | Plane heating type, frequency: | 500 | 2.5 | 12524 |
| | induction | 100 kHz, power density: 1.5 kW/cm² | | | |
| | heating | | | | |

TABLE 10

| | | Number of | | Number of | | | | | |
|---|---|---|---|---|---|---|---|---|---|
| | | iron-based | | iron-based | | | | | |
| | | carbides | | carbides | | | | | |
| | | having an | | having an | | | | | |
| | | equivalent | | equivalent | | | | | Rate of |
| | Standard | circle | | circle | CTS only in | CTS in only | | | increase of |
| | value of | diameter of | | diameter of | first | first | CTS after | CTS after | CTS |
| | nugget | 30 nm or | Standard | 30 nm or | energization | energization | tempering | tempering | (average |
| | end | more per 1 | value | more per 1 | (average | (standard | (average | (standard | value of a |
| | portion | mm² of | HAZ | mm² of | value of 30 | deviation of | value of 30 | deviation | plurality |
| | (3.0 × | nugget end | (1.0 × | HAZ end | sets) | 30 sets) | sets) | of 30 sets) | of joints) |
| Number | 10⁶ × C) | portion | 10⁶ × C) | portion | [kN] | [kN] | [kN] | [kN] | [%] |
| C1 | 1.1E+06 | 4.7E+06 | 3.7E+05 | 2.50E+05 | 5.5 | 0.33 | 8.2 | 0.22 | 49 |
| C2 | 1.1E+06 | 5.1E+06 | 3.7E+05 | 3.80E+06 | 5.5 | 0.34 | 8.4 | 0.16 | 53 |
| C3 | 1.1E+06 | 5.5E+06 | 3.7E+05 | 4.20E+06 | 5.4 | 0.32 | 8.3 | 0.12 | 54 |
| C4 | 1.1E+06 | 1.3E+06 | 3.7E+05 | 4.40E+06 | 5.6 | 0.29 | 8.8 | 0.11 | 57 |
| C5 | 1.1E+06 | 1.2E+06 | 3.7E+05 | 3.75E+07 | 5.5 | 0.29 | 8.1 | 0.15 | 47 |
| C6 | 1.1E+06 | 5.6E+06 | 3.7E+05 | 2.10E+05 | 5.4 | 0.31 | 7.6 | 0.27 | 41 |
| C7 | 1.1E+06 | 5.4E+06 | 3.7E+05 | 3.90E+06 | 5.5 | 0.30 | 7.2 | 0.17 | 31 |

### Examples D1 to D6

A sheet set in which two steel sheets of the same number shown in Table 11 were overlapped was spot welded. The amount of carbon of each steel sheet is as shown in Table 11, and the other additive elements are Si: 0.3% and Mn: 0.9%. The sheet thickness is 1.6 mm. A pressurizing force was constant at 400 kgf, and a current value was 7.5 kA and an energization time was 400 ms in a first energization step, a first non-energization time was 100 ms, a current value was 7.0 kA and an energization time of 400 ms in a second energization step, and a temper energization was performed at a current value of 4.0 kA for an energization time of 2000 ms while pressurization was maintained after energization pause of 1000 ms after second energization. A joint thus obtained was subjected to a CTS test. The results are shown in Table 11.

TABLE 11

| | Amount of | CTS only | | Rate of |
|---|---|---|---|---|
| | C of steel | in first | CTS after | increase |
| | sheet | energization | tempering | of CTS |
| Number | [mass %] | [kN] | [kN] | [%] |
| D1 | 0.15 | 7.8 | 8.0 | 3 |
| D2 | 0.28 | 5.1 | 5.9 | 16 |
| D3 | 0.31 | 4.9 | 6.4 | 31 |
| D4 | 0.33 | 4.5 | 5.8 | 29 |
| D5 | 0.35 | 3.9 | 5.6 | 44 |
| D6 | 0.42 | 3.2 | 5.4 | 69 |

From the above results, when the C content is more than 0.30%, CTS can be further improved.

The contents of the disclosure by Japanese Patent Application Nos. 2021-058351 and 2021-058352 filed on Mar. 30, 2021 are herein entirely incorporated by reference. All publications, patent applications, and technical standards mentioned in the present specification are herein incorporated by reference to the same extent as if each individual publication, patent application, and technical standard were specifically and individually indicated to be incorporated by reference.

### EXPLANATION OF THE REFERENCE NUMERALS

1A, 1B steel sheet
2A, 2B electrode
13 nugget
14 heat-affected zone (HAZ)

1. A spot welded joint of a sheet set in which two or more steel sheets, including at least one steel sheet having a C content of 0.280% by mass or more and 0.700% by mass or less, overlap, wherein:
in a cross section of the sheet set in a sheet thickness direction passing through a central portion of a nugget, an average of ratios of major axes to minor axes (major axes/minor axes) of prior austenite grains in a melting boundary region, which is up to 1 mm inside a melting boundary of a nugget end portion corresponding to a portion that had been a sheet interface, is in a range of 1.0 to 1.5, and a number density of iron-based carbides having an equivalent circle diameter of 30 nm or more in the melting boundary region is 3.0×10⁶×C or more per 1 mm² in a case in which the C content (% by mass) in the steel sheet constituting the sheet set is regarded as C, in which, in a case in which C contents of all the steel sheets constituting the sheet set are not the same, the C for calculating a lower limit value of the number density of the iron-based carbides is a weighted average of values obtained by multiplying the C content in each of the steel sheets constituting the sheet set by a sheet thickness ratio of each of the steel sheets with respect to a total thickness of the sheet set.

2. The spot welded joint according to claim 1, wherein the C contents of all the steel sheets constituting the sheet set are more than 0.300% by mass.

3. The spot welded joint according to claim 1, wherein, in a case in which a C content (% by mass) in a steel sheet having a highest C content in the sheet set is regarded as [C], a tensile strength (MPa) of the steel sheet having the highest C content is 1800×[C]+250 or more.

4. The spot welded joint according to claim 1, wherein the number density of the iron-based carbides having the equivalent circle diameter of 30 nm or more in a region within 500 μm from the nugget end portion of a heat-affected zone present around the nugget end portion is 1.0×10⁶×C or more per 1 mm².

5. The spot welded joint according to claim 1, wherein a residual stress in the central portion of the nugget is less than 90 MPa.

6. A method of manufacturing a spot welded joint, the method comprising:
a first energization step of energizing a sheet set in which two or more steel sheets, including at least one steel sheet having a C content of 0.280% by mass or more and 0.700% by mass or less, overlap at a current value I₁ (kA) while clamping the sheet set in a sheet thickness direction between a pair of electrodes and pressurizing the sheet set;
a first non-energization step of non-energizing the sheet set for a time t_{c1} of 20 ms or more and 200 ms or less after the first energization step;
a second energization step of energizing the sheet set at a current value I₂ (kA) satisfying the following formula (1) for a time t₂ (ms) satisfying the following formula (2), after the first non-energization step:
$$0.6 \leq {I}_{2} / {I}_{1} \leq 1.1 \qquad ( 1 )$$
$$50 \leq {t}_{2} \leq 1000 ; \qquad ( 2 )$$
and
a tempering step of performing tempering under a condition that a tempering temperature is 350° C. or higher and a tempering parameter H calculated according to the following formula (A) is 8000 or more and 18000 or less at the energized position after the elapse of a time t_{c2} (ms) satisfying the following formula (3), after the second energization step:
$${t}_{c 2} > 3.5 \times {10}^{- 3} \times {Ms}^{2} - 3.3 \times Ms + 1100 \qquad ( 3 )$$
$$H = T \times ( log {t}_{HT} + ( 17.7 - 5.8 \times [ C ] ) ) \qquad ( A )$$
wherein:
Ms in the formula (3) means an Ms point calculated by substituting % by mass of each element contained in the steel sheet constituting the sheet set into an element symbol in the following formula (4), in which, in a case in which all the steel sheets constituting the sheet set do not have the same composition, an Ms point of a weighted average of values obtained by multiplying the Ms point calculated for each steel sheet according to the formula (4) for all the steel sheets constituting the sheet set by a sheet thickness ratio of each steel sheet with respect to a total thickness of the sheet set is substituted into the formula (3):
$$Ms ( ° C . ) = 561 - 474 \times C - 33 \times Mn - 17 \times Ni - 17 \times Cr - 21 \times Mo , \qquad ( 4 )$$
in the formula (A), T means a tempering temperature (K) in a vicinity of a nugget end portion formed by the energization; t_{HT} means a tempering time (s); and [C] in means a C content (% by mass) in a steel sheet having a highest C content in the sheet set.

7. The method of manufacturing a spot welded joint according to claim 6, wherein, in the tempering step, the tempering is performed using a heating means selected from the group consisting of a furnace, a laser, a burning iron, a hot plate, and high-frequency induction heating.

8. The method of manufacturing a spot welded joint according to claim 6, wherein: the tempering is performed so that the tempering temperature T is (A_{c1}-30° C.) or lower in the tempering step in a case in which a value calculated according to the following formula (B) is regarded as A_{c1} (° C.):
$${A}_{c 1} ( ° C . ) = 750.8 - 26.6 C + 17.6 Si - 11.6 Mn - 22.9 Cu - 23 Ni + 24.1 Cr + 22.5 Mo - 39.7 V - 5.7 Ti + 232.4 Nb - 169.4 Al - 894.7 B , \qquad ( B )$$
and
% by mass of each element contained in the steel sheet constituting the sheet set is substituted into an element symbol in the formula (B), in which, in a case in which all the steel sheets constituting the sheet set do not have the same composition, the (A_{c1}-30) is determined based on A_{c1} of a weighted average of values obtained by multiplying A_{c1} calculated according to the formula (B) for each steel sheet for all the steel sheets constituting the sheet set by the sheet thickness ratio of each steel sheet with respect to the total thickness of the sheet set.

9. The method of manufacturing a spot welded joint according to claim 6, wherein the C contents of all the steel sheets constituting the sheet set are more than 0.300% by mass.

10. The method of manufacturing a spot welded joint according to claim 6, wherein, in a case in which a C content (% by mass) in a steel sheet having a highest C content in the sheet set is regarded as [C], the spot welded joint is manufactured in which a tensile strength (MPa) of the steel sheet having the highest C content is 1800×[C]+250 or more.

11. The method of manufacturing a spot welded joint according to claim 6, wherein the t_{c2} is 9000 msec or less.

12. The method of manufacturing a spot welded joint according to claim 6, wherein, in the first energization step, the first non-energization step, and the second energization step, a pressuring force applied to the sheet set by the pair of electrodes is constant.
